(19) United States
(12) Patent Application Publication
(10) Pub. No.: US 2026/0263319 A1
(43) Pub. Date: Sep. 10, 2026

(54) BACKBOARD FOR CPR DEVICE HAVING MULTIPLE INFLATABLE CHAMBERS

(71) Applicant: PHYSIO-CONTROL, INC., Redmond, WA (US)

(72) Inventors: Marcus Ehrstedt, Kävlinge (SE); Anja Broman, Malmö (SE); Sara Lindroth, Lund (SE); Lillian Steiner, Kirkland, WA (US); Rose T. Yin, Bellevue, WA (US); Gretchen Rudel, Woodinville, WA (US); Jennifer Eshoua, Seattle, WA (US); Alison Williams, Seattle, WA (US); Doan Huu Dinh, Bellevue, WA (US); Tyson G. Taylor, Bothell, WA (US); Dennis Changmin Sohn, Seattle, WA (US)

(73) Assignee: PHYSIO-CONTROL, INC., Redmond, WA (US)

(21) Appl. No.: 19/555,215

(22) Filed: Mar. 3, 2026

Related U.S. Application Data
(60) Provisional application No. 63/769,667, filed on Mar. 10, 2025.

(51) Int. Cl. A61H 31/00

(52) U.S. Cl. CPC A61H 31/008; A61H 31/006; A61H 2201/0103; A61H 2201/1215; A61H 2201/5007; A61H 2201/5056

(57) ABSTRACT

A backboard for a mechanical CPR device has a backplate having a footprint. The backboard also has a first inflatable chamber coupled to the backplate, the first inflatable chamber, when inflated, configured to extend away from the backplate snugly against a shoulder of a patient and a top side of an extended arm of the patient. The backboard also has a second inflatable chamber coupled to the backplate, the second inflatable chamber, when inflated, configured to extend away from the backplate snugly against a side of the patient and an underside of the extended arm of the patient.

### CROSS-REFERENCES TO RELATED APPLICATIONS

This patent application claims the benefit of U.S. Provisional Application Ser. No. 63/769,667, filed Mar. 10, 2025. Application No. 63/769,667 is incorporated into the present disclosure by this reference.

### TECHNICAL FIELD

The subject matter is related to an apparatus and methods for mechanical cardiopulmonary resuscitation (CPR) devices.

### BACKGROUND

In certain types of medical emergencies a patient's heart stops working. This stops the blood flow, without which the patient may die. Cardiopulmonary resuscitation (CPR) can forestall the risk of death. CPR includes performing repeated chest compressions to the chest of the patient to cause their blood to circulate, and CPR can also include delivering rescue breaths to the patient. CPR is intended to merely maintain the patient until a more definite therapy is made available, such as defibrillation.

Mechanical compression devices for CPR are being increasingly adopted by emergency medical services around the world. Traditionally, CPR has been performed manually by a rescuer. However, during longer duration resuscitations, a rescuer can become fatigued and provide inadequate compressions. Mechanical compression devices have been adopted by many emergency medical services to address these potential drawbacks of manual CPR by a rescuer.

The correct positioning of a mechanical CPR device relative to a patient's chest is critical to provide effective chest compressions. However, once a patient is aligned in a CPR device and the device begins applying compressions, it is possible that the patient's body drifts from the initial aligned position. Because the correct positioning of a CPR device to apply chest compressions in an optimal location is critical for the compressions to be effective, movement of the patient's body within the device can hinder the effectiveness of compressions and cause a number of problems for rescuers.

Configurations of the disclosed technology address shortcomings in the prior art.

### BRIEF DESCRIPTION OF THE DRAWINGS

FIG. 1 illustrates an environment in which a mechanical chest compression device is administering chest compressions to a subject experiencing cardiac arrest.

FIG. 2 illustrates a mechanical chest compression device administering chest compressions to a subject supported by a first bladder and a second bladder.

FIG. 3 illustrates an example backboard including a first array of bladders and a second array of bladders.

FIG. 4 illustrates an example backboard with a first sensor and a second sensor that are configured to transmit data to a processor.

FIG. 5 illustrates an example process for determining a treatment parameter based on a pressure of a fluid in a bladder.

FIG. 6 illustrates an example process for determining a condition of a subject based on removing an artifact associated with a pressure of a fluid in a bladder.

FIG. 7 illustrates an example process for controlling the inflation and deflation of a first bladder and a second bladder based on pressures of the fluid in the first and second bladders.

FIG. 8 illustrates a chest compression device configured to perform various functions described herein.

FIG. 9 illustrates a mechanical cardiopulmonary resuscitation (CPR) device, according to configurations.

FIG. 10 illustrates a backboard for the mechanical CPR device of FIG. 9 having an inflatable portion in a folded, uninflated position, according to configurations.

FIG. 11 illustrates the backboard of FIG. 10 with the inflatable portion in an unfolded, uninflated position.

FIG. 12 illustrates the backboard of FIG. 10 overlaid on a representation of a patient.

FIG. 13 illustrates a front elevational view of the backboard of FIG. 10 implemented with a patient and CPR device.

FIG. 14 illustrates a side elevational view of the backboard of FIG. 10 implemented with a patient and CPR device.

FIG. 15 illustrates a backboard for a mechanical CPR device having a lateral adjustment wedge, according to configurations.

FIG. 16 illustrates a front elevational view of a mechanical CPR device implementing a lateral adjustment wedge, according to a first configuration.

FIG. 17 illustrates a front elevational view of a mechanical CPR device implementing a lateral adjustment wedge, according to a second configuration.

FIG. 18 illustrates a front elevational view of a mechanical CPR device implementing a lateral adjustment wedge, according to a third configuration.

FIG. 19 illustrates a backboard for a mechanical CPR device having an inflatable portion configured to be inflated in a sequence, according to configurations.

FIG. 20 illustrates the backboard of FIG. 19 in a first inflation position.

FIG. 21 illustrates the backboard of FIG. 19 in a fully inflated position.

FIG. 22 illustrates a backboard for a mechanical CPR device having an inflatable portion configured to be inflated in a sequence, according to an additional configuration.

FIG. 23 illustrates a backboard for a mechanical CPR device having an inflatable portion configured to be inflated in a sequence, according to yet another configuration.

FIG. 24 illustrates a backboard for a mechanical CPR device having an inflatable portion configured to be inflated in a sequence, according to yet another configuration, the inflatable portion being in a first inflation position.

FIG. 25 illustrates the backboard of FIG. 24 in a second inflation position.

FIG. 26 illustrates the backboard of FIG. 24 in a fully inflated position.

### DETAILED DESCRIPTION

Various implementations described herein relate to inflatable backboards, particularly backboards that can enhance the administration of chest compressions to a subject (e.g., a patient). Various examples described herein are directed to improvements to the technical field of emergency care. Previously, rescuers relied on solid, non-inflatable backboards that were heavy, large, and difficult to maneuver, particularly in non-clinical, emergency settings. In addition, it was challenging for individual rescuers to lift patients onto solid, non-inflatable backboards. Various implementations of the present disclosure address these and other problems by providing inflatable backboards that are highly portable and can be easily placed under unconscious patients. The use of various inflatable backboards described herein can improve patient care by decreasing the amount of time rescuers take to begin administering chest compressions, either manually or with the use of a mechanical chest compression device.

In some implementations, an inflatable backboard includes one inflatable bladder. The inflatable backboard may include a first inflatable bladder configured to attach to a second inflatable bladder along a median plane of the subject. In some examples, the inflatable backboard includes a third bladder configured to elevate the head of the subject. The inflatable backboard may include an array of bladders wherein each distinct element in the array of bladders is configured to be inflated separately. In various examples, the inflatable backboard is coupled to a processor configured to control the inflation and/or deflation of the inflatable backboard. The processor may be configured to control the inflation and deflation of distinct elements in the array of bladders in order to move the subject along the inflatable backboard. In some implementations, the inflatable backboard is coupled with a mechanical chest compression device to improve administration of chest compressions to the subject. The processor may be configured to inflate and deflate the inflatable backboard concurrently with the chest compressions administered by the mechanical chest compression device. In various examples, the inflatable backboard includes a pressure sensor configured to detect a pressure of a fluid in the inflatable backboard. In some implementations, the inflatable backboard is coupled to a sensor configured to detect a physiological parameter of the subject. The processor may be configured to control the inflation and/or deflation of the inflatable backboard based on the pressure of the fluid in the inflatable bladder or the physiological parameter of the subject. In some examples, the processor is configured to determine a treatment parameter based on the pressure of the fluid in the inflatable backboard and/or the physiological parameter of the subject.

Aspects of the present disclosure are also directed to adjustable support components for implementation with the backboard of a mechanical CPR device. In implementation, such adjustable support components allow for lateral adjustment of a compression point on a patient's chest.

Various implementations of the present disclosure will now be described with reference to the accompanying figures.

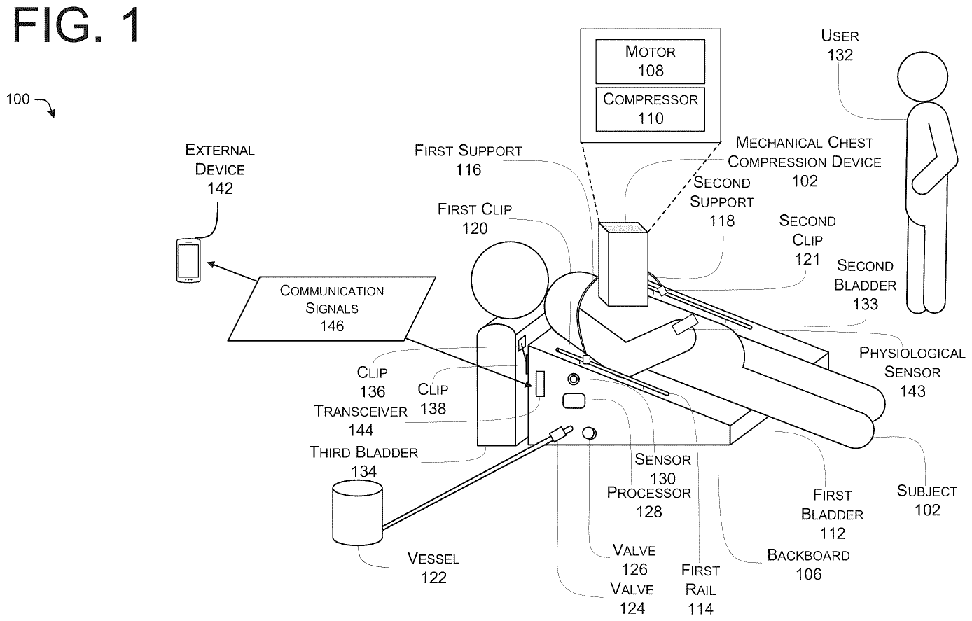

FIG. 1 illustrates an environment 100 in which a mechanical chest compression device 102 is administering chest compressions to a subject 104 experiencing cardiac arrest. During cardiac arrest, the heart of the subject 104 stops effectively pumping blood to a body of the subject 104. For instance, the subject 104 may have an arrhythmia that prevents the heart from effectively pumping blood. The chest compressions are administered to help restore blood circulation to vital organs of the subject 104. The subject 104 is supported by a backboard 106.

The mechanical chest compression device 102 is configured to administer chest compressions to the subject 104. For instance, at least a portion of the mechanical chest compression device 102 is disposed on a chest of the subject. In various implementations, the mechanical chest compression device 102 includes a motor 108 coupled to a compressor 110.

The operation of the mechanical chest compression device 102 may be controlled by at least one processor 128. In various implementations, the motor is 108 communicatively coupled to the processor(s) 128. Specifically, the processor(s) 128 is configured to output a control signal to the motor 108 that causes the motor 108 to actuate the compressor 110. For instance, the motor 108 causes the compressor 110 to administer the compressions to the subject 104 based on the control signal. In some cases, the control signal indicates one or more treatment parameters of the compressions. Examples of treatment parameters include a frequency, timing, depth, force, position, velocity, and acceleration of the compressor 110 administering the compressions. According to various cases, the control signal causes the motor 108 to cease compressions.

The motor 108 is configured to power the compressor 110 to deliver chest compressions to the subject 104. The motor is 108 configured to convert electrical energy stored in a power source into mechanical energy that moves and/or tightens the compressor 110, thereby causing the compressor 110 to administer the force to the chest of the subject 104. In various implementations, the power source is portable. For instance, the power source includes at least one rechargeable (e.g., lithium-ion) battery. In some cases, the power source supplies electrical energy to one or more elements of the mechanical chest compression device 102 described herein.

The compressor 110 physically administers a force to the chest of a subject 104 that compresses the chest of the subject 104. In some examples, the compressor 110 includes at least one piston that periodically moves between two positions (e.g., a compressed position and a release position) at a compression frequency. For example, when the piston is positioned on the chest of the subject, the piston compresses the chest when the piston is moved into the compressed position. A suction cup may be positioned on a tip of the piston, such that the suction cup contacts the chest of the subject 104 during operation.

In some cases, it may be beneficial to reposition the subject 104 onto a firm surface before administering chest compressions. For example, the subject 104 may be in a non-clinical environment (e.g., an airport, a shopping mall, etc.). The subject 104 may, due to cardiac arrest, collapse onto a surface that deforms when chest compressions are administered to the subject 104. The subject 104 may need to be moved to a firm surface before chest compressions are administered to improve the effectiveness of chest compressions. As used herein, the term “firm surface” and its equivalents refers to a surface that does not alter the target chest compression depth more than 20% when chest compressions are administered to a subject on the firm surface. For instance, a firm surface does not significantly alter (by more than 20%) the target depth of chest compressions being administered, either by minimizing surface deformation or by adjusting a chest compression travel distance in response to a detected or predetermined surface deformation to maintain target chest compression depth. In some cases, the subject 104 may be assisted by persons who are not able to move the patient (e.g., lay bystanders).

These issues can be addressed, for example, by using an inflatable backboard (also referred to herein as “backplate”) to provide a firm surface for administering chest compressions. In some implementations, the backboard 106 includes a first bladder 112 configured to be inflated to a rigid state. In various examples, the backboard 106 attaches to the mechanical chest compression device 102 to secure the mechanical chest compression device 102 on the subject 104. In some implementations, the backboard 106 includes a first inflatable bladder (e.g., the first bladder 112) and a second inflatable bladder that are configured to assist with moving and monitoring the subject.

According to various implementations, the first bladder 112 inflates to provide a firm surface to support the subject 104 during chest compressions. The first bladder 112 is configured to inflate to a rigid state and to be airtight. The first bladder 112 may include symbols, marks, or other signage indicating how to position the first bladder 112.

The backboard 106 may include a flexible, non-elastic material, such as polyvinyl chloride (PVC). The elastic modulus of a material within the backboard 106 (e.g., the first bladder 112) is relatively low. In some cases, the first bladder 112 includes a material with an elastic modulus in a range of 1 to 200 GPa. When inflated, the first bladder 112 may be relatively stiff, and may be unable to significantly bend. In some examples, the first bladder 112 includes a material configured to bend at a radius of curvature in a range of 0.2-2 centimeters. For example, the material may be configured to bend at a radius of curvature of 0.5 cm.

The backboard 106, in various cases, can be folded into a relatively small volume when it is not in use. In some implementations, the backboard 106 is configured to fold into a volume of less than 10 centimeters by 30 centimeters when the first bladder 112 is deflated.

To prevent slippage of the subject 104 during chest compressions, the backboard 106 may have a relatively high coefficient of friction. In various cases, the first bladder 112 includes a first material with a coefficient of friction in a range of 0.02-0.2. In some cases, the coefficient of friction is in a range of 0.1-0.2. The first bladder 112, in some instances, includes the first material and a second material with a coefficient of friction in a range of 0.2-1. The coefficient of friction, in some examples, may be in a range of 0.5 to 1. In some examples, the first bladder 112 includes a drop-stitch material that includes PVC, nylon, or polypropylene.

In some cases, the backboard 106 is shaped to enhance the efficacy of chest compressions administered to the subject 104. In some examples, the first bladder 112 includes a wedge shape. For instance, the first bladder 112 may elevate the head of the subject 104 during chest compressions.

In various implementations, the first bladder 112 includes multiple compartments configured to inflate selectively. Selective inflation of distinct compartments may be beneficial to properly and efficiently position the subject 104 onto the first bladder 112. Efficient positioning may improve chances of successful treatment by reducing delay in initiation of chest compressions. For example, the first bladder 112 may include a first compartment configured to inflate first to assist with positioning the first bladder 112 under the subject 104. In some examples, the first bladder 112 includes a second compartment configured to inflate second to secure a position of the first bladder 112. In various examples, the first and second compartments can assist persons who are unable to reposition the subject 104 (e.g., lay bystanders). In some cases, the first bladder 112 includes a third compartment configured to inflate third to elevate the subject. It may be beneficial to elevate a head of the subject 104 above a torso of the subject 104 to improve blood flow to a brain of the subject 104. Accordingly, the third compartment, in some examples, includes a wedge shape to elevate the head of the subject 104 above the torso of the subject 104. According to various implementations, the second compartment includes a material with a higher surface friction than a material included in the first compartment. For example, the second compartment may include a material with a surface friction of 0.5, and the first compartment may include a material with a surface friction of 0.2.

A first rail 114 and a second rail are configured to attach the first bladder 112 to the mechanical chest compression device 102. The first rail 114 and the second rail are disposed on the first bladder 112. According to various instances, the first rail 114 and the second rail are configured to be disposed adjacent to a lateral side of the subject 104. For example, the first rail 114 is, in some implementations, configured to be disposed on the left side of the subject 104, and the second rail is configured to be disposed on the right side of the subject 104. The first rail 114 and the second rail include, in some instances, a rigid material, such as nylon, acetal, high molecular weight polyethylene, stainless steel, titanium, or another rigid material.

A first support 116 and a second support 118 extend from the mechanical chest compression device 102 and are configured to attach to the first rail 114 and the second rail, respectively. The first support 116 and the second support 118 include, in some cases, a rigid material, such as plastic (e.g., polypropylene, polycarbonate, polyoxymethylene, nylon, acetal, high molecular weight polyethylene) or metal (e.g., stainless steel, titanium). In some cases, the first rail 114 and the second rail include an alignment mechanism configured to align the attachment of the first support 116 and the first rail 114 with the attachment of the second support 118 and the second rail. The alignment mechanism, in various implementations, includes marks, incisions, latches, or any other suitable alignment mechanism. The alignment mechanism can assist with proper positioning of the mechanical chest compression device 102 on the subject 104.

A first clip 120 and a second clip 121 are examples of a mechanism configured to secure the first support 116 to the first rail 114 and the second support 118 to the second rail, respectively. The first clip 120 and the second clip 121 are disposed on the first support 116 and the second support 118, respectively. The first clip 120 and the second clip 121, in some examples, are a C-clip, a U-clip, a T-clip, a snap-on clip, a clamp clip, or any other suitable clip. In some cases, the first clip 120 and the second clip 121 are configured to attach to the alignment mechanism.

A vessel 122 storing a fluid is configured to inflate the first bladder 112. The vessel 122 may be a canister, a tank, or any other suitable airtight container. In some cases, the fluid is a gas, such as nitrogen or carbon dioxide. The gas is stored, in various examples, in a compressed state or as a fluid (e.g., liquid nitrogen). According to some cases, the vessel 122 is configured to store the gas at a pressure in a range of 10 to 500 kilopascal (kPa). In some cases, the vessel 122 is configured to inflate, with the gas, the first bladder 112 to a pressure in a range of 13 kPa to 140 kPa. For instance, the pressure of the gas in the vessel 112 is greater than the pressure of the gas in the inflated backboard 106.

In some examples, the vessel 122 includes a first reactant and a heating element to generate the fluid. The first reactant is, in various instances, a solid metal, such as sodium azide. The heating element is configured to heat the first reactant to initiate a reaction, wherein the reaction produces the fluid. The heating element may be an ignitor, an electric current, a hot plate, or any other element with heating capabilities. In some cases, the vessel 122 includes secondary reactant(s) to react with a byproduct of the fluid-producing reaction. For example, the vessel 122 may include potassium nitrate and/or silicon dioxide as secondary reactants. In some cases, the vessel 122 inflates the first bladder 112 by generating a fluid using a first reactant and a second reactant. For example, the vessel 122 may include a first reactant, a second reactant, and a heating element. The heating element is, in some instances, configured to heat the first reactant and the second reactant to initiate a reaction between the first reactant and the second reactant, wherein the reaction produces the fluid. In some examples, the first reactant is a nitrogen-rich fuel and the second reactant is a nonmetallic oxidizer. For example, the first reactant and the second reactant may be guanidinium nitrate and nitrate, respectively.

A first valve 124 and a second valve 126 are configured to control the inflation and/or deflation of the first bladder 112. The first and second valves 124 and 126 are, in some instances, disposed on the vessel and/or the first bladder 112. For example, the first valve 124 may be disposed on the vessel 122, and a second valve 126 may be disposed on the first bladder 112. In various examples, the first and second valves 124 and 126 are mechanical valves such as a spring-loaded valve, a Boston valve, a Halkey-Roberts valve, a Schrader valve, a ball valve, a diaphragm valve, or any other suitable mechanism to control a flow of the fluid. In some examples, the first and second valves 124 and 126 are coupled to a processor 128 that is configured to control the inflation of the first bladder 112 by the vessel 122 and/or the venting of the fluid from the first bladder 112 to the external environment. In various instances, the processor 128 is configured to control the inflation based on the detected pressure of the gas in the first bladder 112. For example, the first bladder 112 may be supporting the subject 104 during chest compressions. The processor 128 may determine, based on the pressure of the gas in the first bladder 112, that the target chest compression depth is altered by more than 20% during chest compressions. Accordingly, the processor 128 may determine a second pressure for the gas in the first bladder 112 to reduce the change in target chest compression depth to 20% or a predetermined value.

In some implementations, the first valve 124 is a flow regulator, the vessel 122 is a first vessel 122, and a second vessel (not illustrated) is disposed between the first vessel 122 and the first valve 124. The second vessel is configured to receive the fluid from the first vessel 122 and store the fluid. The first valve 124 is configured to control the inflation of the first bladder 112 by venting the fluid from the second vessel to the first bladder 112. In some examples, the volume of the second vessel is smaller than the volume of the first vessel 122. In various examples, the second vessel is pressurized to a pressure in a range of 10-500 kPa.

In some implementations, the backboard 106 includes a sensor 130 configured to detect a pressure of the fluid in the first bladder 112. In various examples, the sensor 130 includes a piezoresistive sensor, a capacitive sensor, a piezoelectric sensor, a strain gauge sensor, or any other suitable element capable of detecting a pressure of a fluid. In some cases, the processor 128 is coupled to the sensor 130.

In some cases, it may be beneficial to determine a weight of the subject 104. For instance, the weight of the subject 104 may be used to determine dosages of medications administered by emergency medical personnel or a ventilation rate. In some cases, the weight of the subject 104 may be used to determine a compression/ventilation ratio or a compression depth to be administered to the subject 104. The processor 128 may be configured to determine, based on the pressure of the fluid in the first bladder 112, a parameter representing a physical measurement of the subject 104 (e.g., a weight of the subject 104), chest compressions administered to the subject 104, or a first position of the subject 104. The parameter may be a first compression frequency or a first compression depth of chest compressions administered to the subject 104. In some cases, the processor 128 is configured to determine, based on the parameter, a treatment parameter. The treatment parameter is, in some cases, a second compression depth, a second compression frequency, a compression/ventilation ratio, a ventilation ratio, a ventilation volume, or a ventilation frequency. For example, the processor 128 may be configured to determine the pressure of the fluid in the first bladder 112 over time. For example, the sensor 130 may detect the pressure of the fluid in the first bladder 112 at particular time intervals. The processor 128 may determine, based on the pressure of the fluid in the first bladder 112 over time, a first compression frequency of chest compressions administered to the subject 104. Based on the first compression frequency, the processor 128 determines a rate of ventilation to be administered to the subject 104.

In some examples, the processor 128 may determine, based on the pressure of the fluid in the first bladder 112, a weight of the subject 104. Based on the weight of the subject 104, the processor 128 determines a rate of ventilation, a volume of ventilation, a second compression frequency, a second compression depth, and/or a compression/ventilation ratio to be administered to the subject 104. In some cases, the processor 128 determines whether the subject 104 is an adult subject or a pediatric subject. The processor 128 may determine, based on whether the subject 104 is an adult subject or a pediatric subject, a rate of ventilation, a volume of ventilation, a second compression frequency, a second compression depth, and/or a compression/ventilation ratio to be administered to the subject 104. For instance, the processor 128 may determine that the subject 104 is a pediatric subject and that a compression/ventilation ratio of 15:2 should be administered to the subject 104. In some examples, the processor 128 may determine that the subject 104 is an adult subject and that a compression/ventilation ratio of 30:2 should be administered to the subject 104. The processor 128 may be configured to instruct the user 132 to administer ventilation according to the compression/ventilation ratio. In some cases, the processor may determine that the subject 104 is a pediatric subject and that the second compression depth should be reduced.

In some cases, the subject 104 may gain consciousness and start moving. Movement of the subject 104 can interrupt therapy and/or monitoring of the subject 104, such as by causing an interruption to CPR, a motion artifact in a monitored physiological parameter, or the like. Thus, it may be beneficial to identify movement of the subject 104 caused by the subject 104 and/or to alert the user 132. This issue can be addressed by determining, based on detecting that the subject 104 is moving, that the subject 104 should be sedated to minimize interruptions in chest compressions. According to some implementations, the processor 128 analyzes the first position of the subject 104 and a second position of the subject 104 and determines that the subject 104 is moving. For instance, a change in the pressure of at least one bladder and/or compartment in the backboard 106 may be indicative of movement of the subject 104, particularly if the change is not associated with administration of a treatment (e.g., chest compressions). In response to determining that the subject 104 is moving, the processor 128 may be configured to instruct the user 132 to sedate the subject 104.

In some cases, the processor 128, based on the first position of the subject 104, determines a third position for the subject 104. The third position may allow for more effective chest compressions by the mechanical chest compression device 102. For example, a midline of the subject 104 may be aligned with a midline of the backboard 106 when the subject 104 is in the third position. The processor 128 may be configured to instruct the user 132 to move the subject 104 to the third position. In some cases, the processor 128, based on the first position of the subject 104, determines a fourth position of the mechanical chest compression device 102. The fourth position of the mechanical chest compression device 102 may allow for more effective chest compressions. The processor 128 may be configured to instruct the user 132 to move the mechanical chest compression device 102 to the fourth position.

In some cases, the processor 128 is coupled to the mechanical chest compression device 102 and is configured to cause the mechanical chest compression device 102 to adjust a chest compression parameter based on the pressure of the fluid in the first bladder 112. The chest compression parameter includes, in some examples, a compression depth, a compression frequency, a compression/ventilation ratio, or a compression position.

In some examples, the mechanical chest compression device 102 administers chest compressions to the subject 104 at a chest compression frequency. The mechanical chest compression device 102 may communicate the chest compression frequency to the processor 128. The processor 128 is, in various examples, configured to inflate and deflate the first bladder 112 at the chest compression frequency. In some cases, the processor 128 determines the chest compression frequency based on the pressure of the fluid in the first bladder 112. The sensor 130 may detect the pressure of the fluid at periodic time intervals (e.g., a sampling frequency that is greater than the chest compression frequency). Based on the determined chest compression frequency, the processor 128, in some cases, determines a periodic pattern of inflation and deflation of the first bladder 112 such that the first bladder 112 inflates and deflates at the chest compression frequency.

In some examples, the processor 128 determines that the target chest compression depth is altered by more than 20% during chest compressions administered by the mechanical chest compression device 102 to the subject 104. The processor 128, in various implementations, is configured to determine a change in target chest compression depth to reduce the deformation of the first bladder 112. In some cases, the processor 128 may communicate to the mechanical chest compression device 102 the pressure of the gas in the first bladder 112 or the deformation of the first bladder 112. Based on the pressure of the gas in the first bladder 112 or the deformation of the first bladder 112, the mechanical chest compression device 102 is, in various instances, configured to adjust the compression depth to reduce the change in target chest compression depth. In some implementations, the mechanical chest compression device 102 is configured to communicate the target chest compression depth to the processor 128. Based on the target chest compression depth, the processor 128 may determine that the chest compression depth is altered by more than 20%. The processor 128, in some examples, is configured to determine a pressure of the gas in the first bladder 112 or a second chest compression depth to reduce the change in target chest compression depth. For instance, the processor 128 may communicate to the mechanical chest compression device 102 the second chest compression depth. In some examples, the change in chest compression depth is reduced to 20% or to a predetermined value.

According to various implementations, the backboard 106 includes a second bladder 133 that is configured to attach to the first bladder 112. The second bladder 133 attaches to the first bladder 112 to provide a firm surface for the subject. In various cases, the first bladder 112 is configured to attach to the second bladder 133 along a median plane of the subject 104. As used herein, the term “median plane of the subject,” and its equivalents can refer to a plane that is coplanar with the midline of the subject. The second bladder 133 is configured to inflate and to be airtight. In some examples, the first bladder 112 is configured to be disposed under a first lateral side of the subject 104 (e.g., a left side of a torso of the subject 104). The second bladder 133 is configured to be disposed under a second lateral side of the subject 104 (e.g., a right side of a torso of the subject 104). The second bladder 133 may include symbols, marks, or other signage indicating how to position the second bladder 133.

A third clip and a fourth clip secure the first bladder 112 to the second bladder 133. The third clip is an attachment mechanism disposed on the first bladder 112. The third clip includes, in some cases, a first hook-and-loop fastener, a first magnet, a first ferromagnetic material, a first adhesive strip, a first clip, a first suction cup, or any other suitable attachment mechanism. The fourth clip is an attachment mechanism disposed on the second bladder 133 and configured to attach to the third clip disposed on the first bladder 112. The fourth clip includes, in some cases, a second hook-and-loop fastener, a second magnet, a second ferromagnetic material, a second adhesive strip, a second clip, a second suction cup, or any other suitable attachment mechanism. In some implementations, the first bladder includes a first interlocking shape, and the second bladder includes a second interlocking shape. For example, the first interlocking shape may include a protrusion that fits into a cavity included in the second interlocking shape. The third clip and the fourth clip, in various instances, are disposed on or near the first interlocking shape and the second interlocking shape, respectively.

The vessel 122 is, in some examples, configured to inflate the second bladder 133. In some cases, the vessel 122 is configured to inflate, with the gas, the first bladder 112 and the second bladder 133 to a pressure in a range of 10 kPa to 500 kPa. In some implementations, the backboard 106 is configured to fold into a volume of less than 10 centimeters by 30 centimeters when the first bladder 112 and the second bladder 133 are deflated.

The first valve 124 is, in some examples, configured to control the inflation and/or deflation of the second bladder 133. A valve (e.g., the first valve 124 or the second valve 126) may be disposed on the vessel 122, the first bladder 112, and/or the second bladder 133. For example, the first valve 124 may be disposed on the vessel 122, the second valve 126 may be disposed on the first bladder 112, and a third valve may be disposed on the second bladder 133. In some cases, the first valve 124 is configured to inflate the first bladder 112 and the second bladder 133, the second valve 126 is configured to vent the fluid from the first bladder 112 to an external environment, and the third valve is configured to vent the fluid from the second bladder 133 to the external environment. In various examples, the first valve 124, the second valve 126, and the third valve are coupled to a processor 128 that is configured to control the inflation of the second bladder 133 by the vessel 122 and/or the venting of the fluid from the second bladder 133 to the external environment.

In some cases, the processor 128 is coupled to the first valve 124, the second valve 126, and the third valve and to the mechanical chest compression device 102. The processor 128, according to some examples, causes the motor 108 to move the compressor 110 at a chest compression frequency. The processor 128 causes the first valve 124 to vent the fluid from the vessel 122 into the first bladder 112 and the second bladder 133 at the chest compression frequency, the second valve 126 to vent the fluid from the first bladder 112 to the external environment at the chest compression frequency, and the third valve to vent the fluid from the second bladder 133 to the external environment at the chest compression frequency.

In some instances, the second rail is configured to attach the second bladder 133 to the mechanical chest compression device 102. The second rail, according to various examples, is disposed on the second bladder 133.

In some cases, it may be beneficial to determine a position of the subject 104. For instance, a position of the mechanical chest compression device 102 relative to the subject 104 can be optimized to improve effectiveness of CPR. According to various implementations, the sensor 130 is disposed on the first bladder 112 and/or the second bladder 133 as described herein. For instance, a first sensor (e.g., the sensor 130) may be disposed on the first bladder 112, and a second sensor may be disposed on the second bladder 133. The first sensor (e.g., the sensor 130) is configured to detect a first pressure of the fluid in the first bladder 112 that is representative of a first proportion of the weight of the subject 104. The second sensor is configured to detect a second pressure of the fluid in the second bladder 133 that is representative of a second proportion of the weight of the subject 104. In some examples, the first sensor (e.g., the sensor 130) and the second sensor are coupled to the processor 128. The processor 128 is configured to determine, based on the first pressure and the second pressure, a first position of the subject 104. The processor may determine, based on the first position of the subject 104, a position of the mechanical chest compression device 102. In some examples, the processor may determine, based on the first pressure and the second pressure, a weight of the subject 104.

In some cases, the processor 128 may identify, based on the first pressure and the second pressure, that the subject 104 is disproportionately supported by the first bladder 112 and identify a second position where the subject 104 is supported by the first bladder 112 and the second bladder 133 equally. The processor 128 determines a third pressure for the first bladder 112 and a fourth pressure for the second bladder 133 to move the subject 104 to the second position. For example, the processor 128 may determine that the third pressure for the first bladder 112 is greater than the fourth pressure for the second bladder 133, allowing the subject 104 to move towards the second bladder 133. Upon detecting that the subject 104 is equally supported by the first bladder 112 and the second bladder 133, the processor 128 may equalize the pressure in the first bladder 112 and the second bladder 133.

In some instances, the first sensor (e.g., the sensor 130) and the second sensor detect a first pressure and/or a second pressure over a time interval. Based on the first pressure and the second pressure over the time interval, the processor 128, in various cases, detects local maxima in the first pressure and/or the second pressure to detect chest compressions administered to the subject 104.

In various examples, the backboard 106 includes a third bladder 134 configured to elevate a head of the subject 104 above a torso of the subject 104. In some cases, the third bladder 134 is configured to elevate the head of the subject 104 at an angle in the range of 0 to 45 degrees from a coronal plane of the subject 104. The third bladder 134 is configured to be disposed under the head of the subject 104 and inflate at a greater height than the first bladder 112 or the second bladder 133. The third bladder 134 is, according to various instances, coupled to the vessel 122. The third bladder 134 may include a fifth clip 136 that is configured to attach to a sixth clip 138 disposed on the first bladder 112 and/or a seventh clip disposed on the second bladder 133. The fifth clip 136, the sixth clip 138, and the seventh clip are, in some cases, hook-and-loop fasteners, magnets, ferromagnetic materials, adhesive strips, clips, suction cups, or any other suitable attachment mechanisms. In some cases, the third bladder 134 includes a flexible, non-elastic material, such as polyvinyl chloride (PVC). In some cases, the third bladder 134 includes a material with an elastic modulus in a range of 1-200 GPa. In some cases, the third bladder 134 includes a material configured to bend at a radius of curvature of 2 centimeters of less. In some examples, the third bladder 134 includes a drop-stitch material that includes PVC, nylon, or polypropylene.

In one implementation, the first bladder 112 is a first array of bladders, and the second bladder 133 is a second array of bladders. The first array of bladders and the second array of bladders extend in a first direction and a second direction. The first direction and the second direction are, in some cases, coplanar and/or intersecting. For instance, the two directions may intersect at a 15° angle, 30° angle, 45° angle, 90° angle, or any other suitable angle. According to some implementations, the first bladder 112 and the second bladder 133 are configured to support the subject 104 in a direction perpendicular to a plane of the first direction and the second direction.

According to various implementations, the third bladder 134 is a third array of bladders configured to elevate a head of the subject 104. The third array of bladders is configured to be disposed under the head of the subject 104 and to inflate to a greater height than the first array of bladders or the second array of bladders.

In some instances, the inflation and deflation of the first array of bladders and second array of bladders is controlled by an inflation system. The inflation system includes, for instance, the vessel 122 and the first and second valves 124 and 126. The vessel 122 is, in some examples, configured to selectively inflate the first array of bladders and the second array of bladders. For example, the vessel 122 may be connected to distinct elements in the arrays, enabling each distinct element to be inflated separately. In some examples, the vessel 122 is configured to selectively inflate a first subset of the bladders, wherein the first subset of bladders is included in the first array of bladders, and a second subset of the bladders, wherein the second subset of the bladders is included in the second array of bladders. As used herein, the term “subset,” and its equivalents can refer to a group of one or more entities selected from a set of the entities. For example, the second subset of the bladders may refer to one or more distinct elements in the second array of bladders.

Valve(s) (e.g., the first and second valves 124 and 126) may be disposed on distinct elements in the first and second arrays of bladders, enabling selective inflation and deflation of the backboard to move the subject 104 along the backboard 106. In some cases, a first valve(s) (e.g., the first valve 124) controls venting of the fluid from the vessel 122 to the first subset of the bladders, and a second valve(s) (e.g., the second valve 126) controls venting of the fluid from the first subset of the bladders to the external environment. A third valve(s), in various instances, controls venting of the fluid from the vessel 122 to the second subset of the bladders, and a fourth valve(s) controls venting of the fluid from the second subset of the bladders to the external environment.

According to various implementations, the processor 128 is configured to control the selective inflation and deflation of the first array of bladders and the second array of bladders to move the subject 104 relative to the backboard 106. The processor 128 may be configured to control the selective inflation and deflation of the first subset of the bladders and the second subset of the bladders. For instance, the processor 128 may be configured to cause the inflation system to deflate the first subset of the bladders and inflate the second subset of the bladders. In response to causing the inflation system to deflate the first subset of the bladders and inflate the second subset of the bladders, the processor 128 is, in various implementations, configured to cause the inflation system to inflate the first subset of the bladders.

In some instances, the processor 128 causes the inflation and/or the deflation of the backboard 106 based on input from the user 132. According to various implementations, the processor 128 is configured receive input from the user 132. For example, based on user input that the subject 104 needs to be moved, the processor 128 causes, in some examples, the inflation system to inflate the first subset of the bladders and deflate the second subset of the bladders, causing the subject 104 to move relative to the backboard 106. The user 132 indicates that the subject 104 has moved, and based on the user input that the subject 104 has moved, the processor 128 causes the inflation system to inflate the second subset of the bladders. In some examples, the user 132 may indicate that the subject 104 is pregnant. The processor 128 outputs instructions, such as adjusting the compression depth or applying left uterine displacement.

According to some implementations, sensors (e.g., the sensor 130) are disposed on the first and second arrays bladders to detect the pressure of the fluid in the first and second arrays of bladders. For example, a first pressure of the fluid in the first array of bladders may be detected by a first sensor (e.g., the sensor 130), and a second pressure of the fluid in the second array of bladders may be detected by a second sensor. In some cases, two or more sensors are disposed on each of the first and second arrays of bladders to detect the pressure of the fluid in distinct elements of the first and second arrays of bladders.

According to various instances, the processor 128 is configured to determine a first position of the subject 104 based on the pressures detected by the sensors (e.g., the sensor 130). In some cases, the processor 128 may be configured to determine whether a center of gravity of the subject 104 is askew from a center line of the backboard 106. In response to determining that the center of gravity of the subject 104 is askew from the center line of the backboard 106, the processor 128 causes, in various instances, the inflation system to change the pressure in the first and second arrays of bladders to move the subject 104 to a second position. For example, the processor 128 may determine that a first pressure of the first array of bladders is lower than a second pressure of the second array of bladders. The processor 128 may determine that the subject 104 is disproportionately supported by the second array of bladders. In some instances, the processor 104 causes the inflation system to deflate the first array of bladders and inflate the second array of bladders. In response to causing the inflation system to deflate the first array of bladders and inflate the second array of bladders, the processor 128 is, in various examples, configured to cause the inflation system to inflate the first array of bladders. In some cases, the processor 128 causes the inflation system to inflate the second array of bladders in response to determining that the subject 104 has moved. For example, the processor 128 may determine that the second pressure in the second array of bladders has reduced, indicating that the center of gravity of the subject 104 has moved towards the center line of the backboard 106. In response to determining that the subject 104 has moved, the processor, in some cases, causes the inflation system to inflate the second array of bladders. In some cases, the processor 128 causes the inflation system to inflate and/or deflate the first subset of the bladders and/or the second subset of the bladders to move the subject.

In various examples, the processor 128 is configured to detect chest compressions administered to the subject 104 by analyzing the pressures detected by the sensors (e.g. the sensor 130). For example, the processor 128 may detect a first pressure in the first array of bladders and a second pressure in the second array of bladders over a time interval. The processor 128 may determine that the first pressure and the second pressure oscillate over time with a frequency in a range of 100-120 oscillations per minute. Based on determining that the first pressure and the second pressure oscillate with a frequency in a range of 100-120 oscillations per minute, the processor 128 may determine a chest compression frequency equal to the frequency. The processor 128 is, in some cases, configured to output an indication of the chest compressions to the user 132, to an external device 142, or to another entity to assist with the medical care of the subject. The indication of the chest compressions includes a compression frequency, a compression depth, a compression position, or any other information related to the chest compressions administered to the subject 104.

For example, the processor 128 is, in various instances, configured to determine a position of the subject 104 based on the first pressure in the first array of bladders and the second pressure in the second array of bladders. According to some implementations, the processor 128 determines a compression position based on the first pressure and the second pressure. Based on the position of the subject 104 and the compression position, the processor may determine a second compression position, which enables more effective chest compressions. In some examples, the processor 128 outputs, to the user 132, to an external device 142, or to another entity involved in the medical care of the subject 104, an instruction to administer chest compressions at the second compression position.

In various examples, the processor 128 is configured to assist with positioning the mechanical chest compression device 102 on the subject 104. The mechanical chest compression device 102 attaches to the first rail 114 and the second rail, which are disposed on the first array of bladders and the second array of bladders, respectively. The processor 128 is coupled to the mechanical chest compression device 102 and, in some cases, outputs the instruction to administer chest compressions at the second compression position to the mechanical chest compression device. In some cases, the mechanical chest compression device 102 attaches to the first rail 114 and the second rail using the first clip 120 and the second clip 121. In various instances, the first rail and the second rail are coupled to an actuator that controls the position of the mechanical chest compression device 102 along the first rail and the second rail. The actuator is, in some examples, a servo motor, a magnetic actuator, a shape memory alloy actuator, or any other rotary or linear actuator that enables dynamic positioning. In some instances, the actuator is controlled externally. According to some implementations, the mechanical chest compression device 102 is configured to reposition the compressor 110 based on the compression position. In some examples, the mechanical chest compression device 102 is configured to change a compression parameter based on user input. For example, the processor 128 may receive user input from the user 132 or from the external device 142 that the subject 104 is pregnant, and the mechanical chest compression device 102 may alter the compression depth.

According to some implementations, the processor 128 is configured to analyze a physiological parameter of the subject 104 to determine a treatment to be administered to the subject 104. In various examples, a physiological parameter is detected by a physiological sensor 143 from the subject 104 and analyzed by the processor 128. The physiological parameter includes a blood oxygenation, a heart rate, a blood velocity, a pulse rate, a blood pressure, an ECG, a transthoracic impedance, an airway parameter (e.g., partial pressure of carbon dioxide (CO₂) and/or oxygen (O₂) in an airway of the subject 104), an acceleration of the subject 104, or any other physiological measurement related to the subject 104. In some cases, the parameter is detected at a sampling frequency such that the parameter can be represented as a waveform (e.g., a photoplethysmograph, a capnograph, or the like). The physiological parameter may be detected by the physiological sensor 143 that is coupled to the processor 128. For example, the physiological parameter may be a partial pressure of CO₂ of the subject 104. In some examples, the processor 128 may determine, based on a partial pressure of CO₂and a first compression frequency, a second compression frequency, a ventilation rate, or a volume of ventilation to be administered to the subject 104.

In some implementations, the processor 128 is configured to remove an artifact associated with the physiological parameter of the subject 104 to determine a condition of the subject 104. In various instances, the processor 128 detects a position of the subject 104, a movement of the subject, and/or chest compressions administered to the subject 104 over a time interval. The processor 128 is configured to remove an artifact associated with the position of the subject 104, the movement of the subject 104, and/or chest compressions administered to the subject 104 from the physiological parameter of the subject 104. For example, the processor 128 may analyze an ECG of the subject 104 collected over a first time interval and remove an artifact associated with a movement of the subject 104 detected over the first time interval. Based on removing the artifact associated with the movement, the processor 128 may determine that the subject 104 is experiencing ventricular fibrillation (VF), pulseless ventricular tachycardia (VT), or another condition associated with the health of the subject. In some cases, the processor 128 receives a physiological parameter associated with an airway of the subject, such as a respiratory rate, a tidal volume, airway resistance, or an oxygen saturation level. The processor 128 may determine, based on removing an artifact associated with the position of the subject 104, the movement of the subject 104, and/or chest compressions administered to the subject 104, that the subject 104 is spontaneously breathing. In some cases, the physiological parameter is associated with an acceleration of the subject 104, and the processor 128 determines, based on removing an artifact associated with the position of the subject 104, the movement of the subject 104, and/or chest compressions administered to the subject 104, that the subject 104 is conscious.

In some examples, the backboard 106 is configured to be portable and operated outside a clinical environment. For instance, the subject 104 may experience cardiac arrest in an airport, at a shopping mall, at the scene of a car crash, or in another non-clinical environment. In various cases, the user 132 operating the backboard is an untrained user, such as a bystander. In some cases, it may be advantageous for the backboard 106 to communicate with the external device 142 until the subject 104 is transferred to a clinical care environment. According to some examples, the backboard 106 includes a transceiver 144 to assist with the medical care of the subject 104. The transceiver 144, in some cases, is an antenna configured to transmit and receive communication signals 146 using one or more wireless networks. Examples of wireless networks include WI-FI®, cellular networks, wireless local area networks (WLANs), and BLUETOOTH®. In some instances, the communication signals are electromagnetic (EM) signals, radio waves, or the like. In some examples, the transceiver 144 transmits radio waves to the external device 142 via a cell tower. In some cases, the transceiver 144 is connected to a wireless modem in the backboard 106, such as a modem for engaging in WI-FI®, WIGIG®, WIMAX®, BLUETOOTH®, or infrared communication.

The transceiver 144, in various instances, transmits communication signals 146 indicative of pressures detected by the sensors (e.g. the sensor 130). For example, the transceiver 144 may transmit communication signals 146 indicative of a pressure in the first bladder 112. In some cases, the transceiver 144 may transmit communication signals 146 indicative of a first pressure of the fluid in the first bladder 112 and a second pressure of the fluid in the second bladder 133. According to various implementations, the processor 128 causes the transceiver 144 to transmit communication signals 146 to the external device 142. In some cases, the transceiver 144 receives communication signals 146 from the external device 142, and the transceiver 144 provides the received communication signals 146 to the processor 128 for further analysis. The processor 128, according to various examples, is configured to cause the inflation system to change a pressure in a bladder (e.g., the first bladder 112, the second bladder 133, the first subset of the bladders, or the second subset of the bladders), to cause the mechanical chest compression device 102 to change a compression parameter (e.g., a compression frequency, a compression depth, or a compression location), or to output an instruction to the user 132. In some examples, the external device 142 is located remotely from the backboard 106, such as at a remote clinical environment (e.g., a hospital). Examples of the external device 142 include a device operated by a care provider (e.g., a physician), a device configured to analyze or store data, a device configured to assist with monitoring or treatment of the patient, or any other device related to medical care. The external device 142 is, in some cases, a mobile device, an Internet of Things (IoT) device, a computer (e.g., a laptop device, a server, etc.), or any other network device configured to communicate over a communication network.

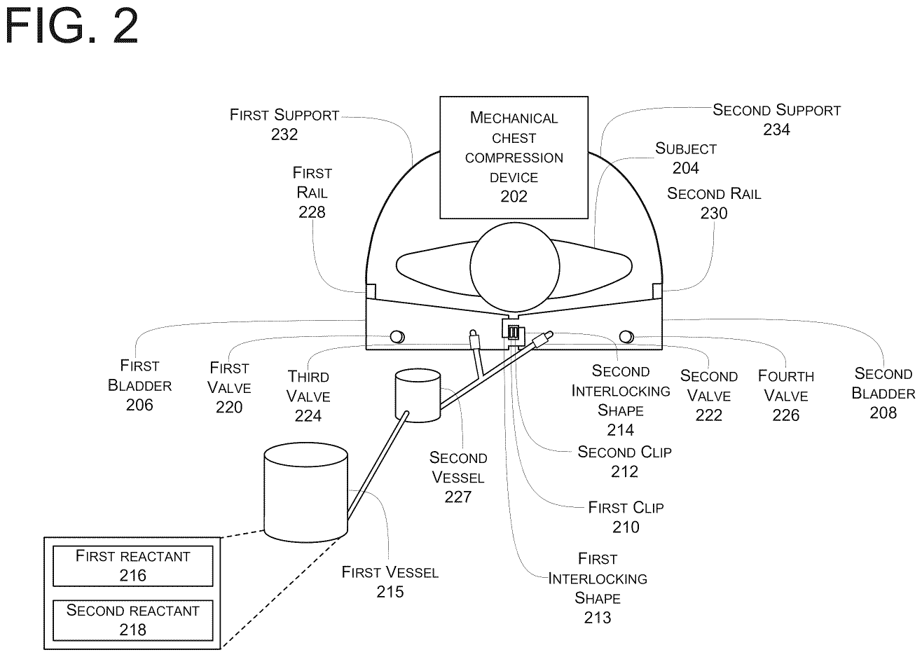

FIG. 2 illustrates a mechanical chest compression device 202 administering chest compressions to a subject 204 supported by a first bladder 206 and a second bladder 208. According to various implementations, the first bladder 206 is configured to attach to the second bladder 208 to provide a firm surface for the subject 204. In various cases, the first bladder 206 is configured to attach to the second bladder 208 along a median plane of the subject 204. In some examples, the first bladder 206 is configured to be disposed under a first lateral side of the subject 204 (e.g., a left side of a torso of the subject 204). The second bladder is 208 configured to be disposed under a second lateral side of the subject 204 (e.g., a right side of a torso of the subject 204).

A first clip 210 and a second clip 212 secure the first bladder 206 to the second bladder 208. The first clip 210 is an attachment mechanism disposed on the first bladder 206. The first clip 210 includes, in some cases, a first hook-and-loop fastener, a first magnet, a first ferromagnetic material, a first adhesive strip, a first clip, a first suction cup, or any other suitable attachment mechanism. The second clip 212 is an attachment mechanism disposed on the second bladder 208 and configured to attach to the first clip 210 disposed on the first bladder 206. The second clip 212 includes, in some cases, a second hook-and-loop fastener, a second magnet, a second ferromagnetic material, a second adhesive strip, a second clip, a second suction cup, or any other suitable attachment mechanism.

In some examples, a first interlocking shape 213 fits into to a second interlocking shape 214 to attach the first bladder 206 to the second bladder 208. The first bladder 206 includes the first interlocking shape 213, and the second bladder 208 includes the second interlocking shape 214. The first interlocking shape 213 may be a protrusion, a male part, or another shape. The second interlocking shape 214 may be a cavity, a female part, or another complementary shape to the first interlocking shape 213. In some cases, the first clip 210 and the second clip 212 are disposed on or near the first interlocking shape 213 and the second interlocking shape 214, respectively.

A first vessel 215 is configured to inflate the first bladder 206 and the second bladder 208 by generating a fluid using a first reactant 216 and a second reactant 218. In some examples, the first reactant 216 is a nitrogen-rich fuel and the second reactant 218 is a nonmetallic oxidizer. For example, the first reactant 216 and the second reactant 218 may be guanidinium nitrate and nitrate, respectively. In some cases, the first vessel 215 may include the first reactant 216, the second reactant 218, and a heating element. The heating element is, in some instances, configured to heat the first reactant 216 and the second reactant 218 to initiate a reaction between the first reactant 216 and the second reactant 218, wherein the reaction produces the fluid. The heating element may be an ignitor, an electric current, a hot plate, or any other element with heating capabilities. In some examples, the first vessel 215 includes the first reactant 216 and the heating element to generate the fluid. The first reactant 216 is, in various instances, sodium azide. In some cases, the first vessel 215 includes second reactant(s) 218 to react with a byproduct of the fluid-producing reaction. For example, the first vessel 215 may include potassium nitrate and/or silicon dioxide as second reactant(s) 218. The first vessel 215 may be a canister, a tank, or any other suitable airtight container.

In some examples, a first valve 220, a second valve 222, a third valve 224, and a fourth valve 226 are configured to control the inflation and/or deflation of the first bladder 206 and the second bladder 208, respectively. The first valve 220 may be disposed on the first bladder 206, the second valve 222 may be disposed on the second bladder 208. In some cases, the first valve 220 is configured to inflate the first bladder 206, and the second valve 222 is configured to inflate the second bladder 208. In various examples, the third valve 224 is configured to vent the fluid from the first bladder 206 to an external environment, and the fourth valve 226 is configured to vent the fluid from the second bladder 208 to the external environment.

In various implementations, the first valve 220 and the second valve 222 are flow regulators, and a second vessel 227 is disposed between the first vessel 215 and the first and second valves 220 and 222. The second vessel 227, in some cases, is configured to transiently store the fluid produced in the first vessel 215. The second vessel 227 may store the fluid at a pressure in a range of 10-500 kPa. According to some examples, the first valve 220 is configured to control the inflation of the first bladder 206 by venting the fluid from the second vessel 227 to the first bladder 206, and the second valve 222 is configured to control the inflation of the second bladder 208 by venting the fluid from the second vessel 227 to the second bladder 208. In some examples, the volume of the second vessel 227 is smaller than the volume of the first vessel 215.

A first rail 228 and a second rail 230 are configured to attach the first bladder 206 and the second bladder 208 to the mechanical chest compression device 202. According to various implementations, the first rail 228 is disposed on the first bladder 206, and the second rail 230 is disposed on the second bladder 208. According to various instances, the first rail 228 and the second rail 230 are configured to be disposed adjacent to a lateral side of the subject 204. For example, the first rail 228 is, in some implementations, configured to be disposed on the left side of the subject 204, and the second rail 230 is configured to be disposed on the right side of the subject 204. The first rail 228 and the second rail 230 include, in some instances, a rigid material, such as nylon, acetal, high molecular weight polyethylene, stainless steel, titanium, or another rigid material.

A first support 232 and a second support 234 extend from the mechanical chest compression device 202 and are configured to attach to the first rail 228 and the second rail 230, respectively. The first support 232 and the second support 234 include, in some cases, a rigid material, such as plastic (e.g., polypropylene, polycarbonate, polyoxymethylene, nylon, acetal, high molecular weight polyethylene) or metal (e.g., stainless steel, titanium).

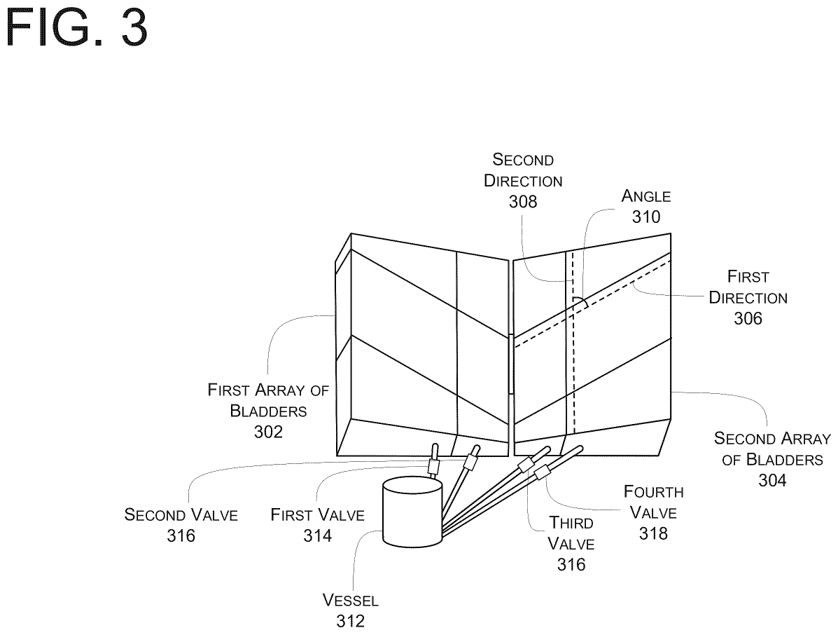

FIG. 3 illustrates an example backboard including a first array of bladders 302 and a second array of bladders 304. The first array of bladders 302 and the second array of bladders 304 extend in a first direction 306 and a second direction 308. The first direction 306 and the second direction 308 are, in some cases, coplanar and intersecting. The first direction 306 and the second direction 308 intersect at an intersection angle 310. For instance, the intersection angle 310 may be 15°, 30°, 45°, 90°, or any other suitable angle.

According to various implementations, a vessel 312 is configured to selectively inflate distinct elements in the first array of bladders 302 and the second array of bladders 304 with a fluid. The vessel 312 may be connected to the distinct elements of the first array of bladders 302 and the second array of bladders 304. In some examples, valves 314, 316, 318, 320, and 322 are configured to control the inflation of the distinct elements of the first array of bladders 302 and the second array of bladders 304.

In some implementations, the first array of bladders 302 includes a first interlocking shape (e.g. the first interlocking shape 213), and the second array of bladders 304 includes a second interlocking shape (e.g., the second interlocking shape 214). The first and second interlocking shapes may include distinct elements that can be inflated selectively. In some examples, the vessel 312 is connected to the distinct elements in the first and second interlocking shapes. The vessel 312 may be configured to control the inflation of the distinct elements of the first and second interlocking shapes to connect the first interlocking shape to the second interlocking shape while inflating the first array of bladders 302 and the second array of bladders 304.

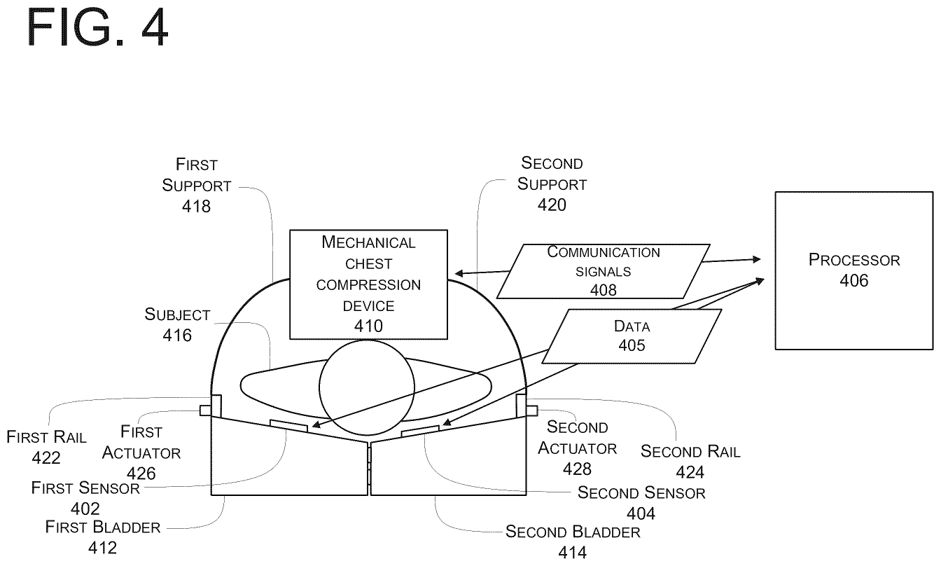

FIG. 4 illustrates an example backboard with a first sensor 402 and a second sensor 404 that are configured to transmit data 405 to a processor 406. According to various implementations, the processor 406 is configured to transmit communication signals 408 with a mechanical chest compression device 410.

In various examples, the first and second sensors 402 and 404 are configured to detect a pressure of a fluid in the example backboard. The first sensor 402, according to some implementations, is disposed on a first bladder 412, and the second sensor 404 is disposed on a second bladder 414. In various examples, the first and second sensors 402 and 404 include a piezoresistive sensor, a capacitive sensor, a piezoelectric sensor, a strain gauge sensor, or any other suitable element capable of detecting a pressure of a fluid.

A first reactant and a heating element are configured to inflate the first bladder 412 and the second bladder 414 by causing a fluid-producing reaction. In some examples, the first reactant and the heating element are disposed inside the first bladder 412 and the second bladder 414. The first reactant is, in various instances, a solid metal, such as sodium azide. The heating element is configured to heat the first reactant to initiate a reaction, wherein the reaction produces the fluid. The heating element may be an ignitor, an electric current, a hot plate, or any other element with heating capabilities. In some cases, a secondary reactant(s) is disposed inside the first bladder 412 and the second bladder 414 to react with a byproduct of the fluid-producing reaction. For example, the vessel 122 may include potassium nitrate and/or silicon dioxide as secondary reactants. In some implementations, the first reagent, a second reagent, and the heating element are configured to inflate the first bladder 412 and the second bladder 414. The heating element is, in some instances, configured to heat the first reactant and the second reactant to initiate a reaction between the first reactant and the second reactant, wherein the reaction produces the fluid. In some examples, the first reactant is a nitrogen-rich fuel and the second reactant is a nonmetallic oxidizer. For example, the first reactant and the second reactant may be guanidinium nitrate and nitrate, respectively.

The first sensor 402 is configured to detect a first pressure of a fluid in the first bladder 412, and the second sensor 404 is configured to detect a second pressure of the fluid in the second bladder 414. The first sensor 402 and the second sensor 404 are, in various examples, configured to transmit data 405 indicative of the first pressure and the second pressure to the processor 406.

According to various examples, the processor 406 may be configured to determine, based on the first pressure and the second pressure, a first position of the subject 416. The processor 406 may identify that the subject 416 is disproportionately supported by the first bladder 412 and identify a second position where the subject 416 is supported by the first bladder 412 and the second bladder 414 equally. The processor 406, in some examples, determines a third pressure for the first bladder 412 and a fourth pressure for the second bladder 414 to move the subject 416 to the second position. For example, the processor 406 may determine that the third pressure for the first bladder 412 is greater than the fourth pressure for the second bladder 414, allowing the subject 416 to move towards the second bladder 414. Upon detecting that the subject 416 is equally supported by the first bladder 412 and the second bladder 414, the processor 406 may equalize the pressure in the first bladder 412 and the second bladder 414.

In some instances, the first sensor 402 and the second sensor 404 detect the first pressure and/or the second pressure over time. For example, the first sensor 402 may detect the first pressure of the fluid in the first bladder 412 at a rate in a range of 1-125 hertz (Hz). In another example, the second sensor 404 may detect the second pressure of the fluid in the second bladder 414 every 0.1 seconds. Based on the first pressure over time and the second pressure over the time, the processor 406, in various cases, detects local maxima in the first pressure and/or the second pressure to detect chest compressions administered to the subject 416.

In some implementations, the processor 406 is configured to determine a compression parameter of chest compressions to be administered to the subject 416. In various examples, the processor 406 determines, based on the first pressure over time and the second pressure over time, a first compression depth, a first compression frequency, or a first compression position of chest compressions administered to the subject 416. In some cases, the processor 406 may determine a second compression position to improve the effectiveness of chest compressions administered to the subject 416. The processor 406 may be configured to instruct the mechanical chest compression device 410 to move the compressor to the second compression position. In some examples, the processor 406 may determine the compression parameter after receiving data from a user (e.g., the user 132). For example, the processor 406 may receive data from the user that the subject 416 is pregnant. The processor 406 may determine a second compression depth to improve the effectiveness of chest compressions administered to the subject 416.

In various examples, the processor 406 is configured to assist with positioning the mechanical chest compression device 410 on the subject 416. A first support 418 and a second support 420 extend from the mechanical chest compression device 410 and are configured to attach to a first rail 422 on the first bladder 412 and a second rail 424 on the second bladder 414. In various instances, the first rail 422 and the second rail 424 are coupled to a first actuator 426 and a second actuator 428, respectively, that control the position of the mechanical chest compression device 410 along the first rail 422 and the second rail 424. The first actuator 426 and the second actuator 428 are, in some examples, a servo motor, a magnetic actuator, a shape memory alloy actuator, or any other rotary or linear actuator that enables dynamic positioning. In some instances, the first actuator 426 and the second actuator 428 are controlled externally. For example, the processor may be configured to cause the first actuator 426 and the second actuator 428 to reposition the mechanical chest compression device 410 along the first rail 422 and the second rail 424.

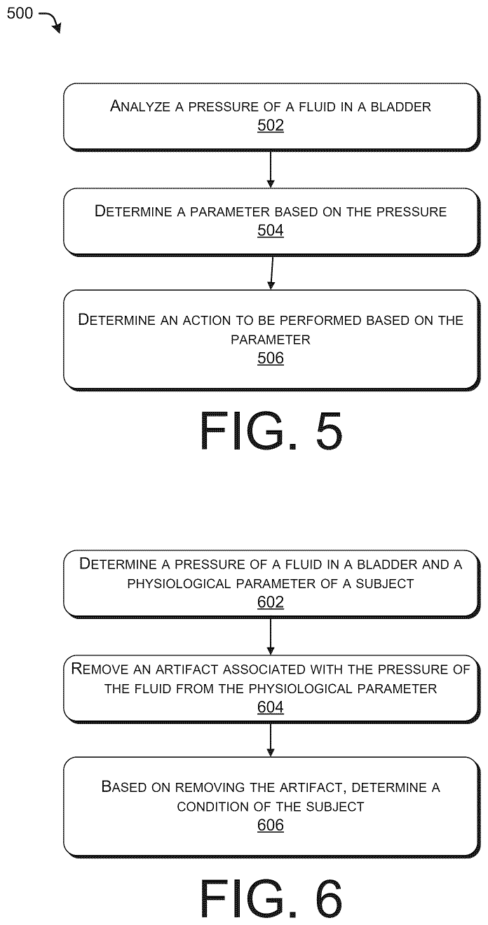

FIG. 5 illustrates an example process for determining a treatment parameter based on a pressure of a fluid in a bladder (e.g., the first bladder 112, the first bladder 206, or the second bladder 208). According to various implementations, the bladder is disposed under a subject (e.g., the subject 104). The process 500 is performed, in some examples, by a processor (e.g., the processor 128), an external device (e.g., the external device 142), a medical device (e.g., the mechanical chest compression device 102), or a trained person (e.g., an emergency medical technician, a physician, a nurse, or the like).

At 502, the pressure of the fluid in the bladder is analyzed. The pressure, in various cases, is a pressure detected at a particular time. In some cases, the pressure is detected at certain time intervals to determine a pressure over time. For example, the pressure may be detected every 0.1 seconds.

At 504, a parameter is determined based on the pressure of the fluid in the bladder. In various examples, the parameter is a weight of the subject (e.g., the subject 104), a position of the subject, a compression frequency, a compression depth, or a compression position. In some examples, local maxima in the first pressure over time and/or the second pressure over time are detected. Based on the local maxima, compression parameters (e.g., the compression frequency) are determined.

At 506, an action to be performed is determined based on the parameter. In various examples, the action is instructing a user to change the parameter. For example, the weight of the patient may be determined based on the pressure of the fluid in the bladder. Based on the weight of the patient, the user may be instructed to set a compression frequency or a compression depth of chest compressions administered to the subject (e.g., the subject 104). In another example, the parameter is the position of the subject, and the action to be performed is to position a mechanical chest compression device (e.g., the mechanical chest compression device 102) on the subject. In some examples, a processor (e.g., the processor 128) performs the process 500 and causes the mechanical chest compression device to change a compression parameter (e.g., a compression frequency, a compression depth, or a compression position). In some cases, the processor causes the inflation and/or deflation of the bladder. For example, the parameter may be a compression frequency, and the processor may determine a periodic pattern of inflation and deflation of the bladder such that the bladder inflates and deflates at the compression frequency.

In some examples, the action to be performed is based on the parameter and a physiological parameter detected from the subject. For example, a processor (e.g., the processor 128) may be configured to analyze the parameter and the physiological parameter to determine a treatment to be administered to the subject (e.g., the subject 104). In various examples, a physiological parameter is detected by a physiological sensor (e.g., the physiological sensor 143) from the subject and analyzed by the processor. The physiological parameter includes a blood oxygen level, a heart rate, a blood pressure, an ECG, an airway measurement, an acceleration of the subject, or any other physiological measurement related to the subject. The physiological sensor may be coupled to the processor. For example, the physiological parameter may be a partial pressure of CO2 level of the subject. In some examples, the processor may determine, based on a partial pressure of CO2 level and a first compression frequency, a second compression frequency, a ventilation rate, or a volume of ventilation to be administered to the subject.

FIG. 6 illustrates an example process for determining a condition of a subject based on removing an artifact associated with a pressure of a fluid in a bladder. According to various implementations, the bladder (e.g., the first bladder 112, the first bladder 206, or the second bladder 208) is disposed under the subject (e.g., the subject 104). The process 600 is performed, in various cases, by a processor (e.g., the processor 128), an external device (e.g., the external device 142), or another medical device (e.g., the mechanical chest compression device 102).

At 602, the pressure of the fluid in the bladder and a physiological parameter of the subject are determined. In some implementations, the pressure may be detected by a pressure sensor disposed on the bladder. In various examples, the pressure sensor is configured to transmit data indicative of the pressure to the processor (e.g., the processor 128), the external device (e.g., the external device 142), or another medical device. In some cases, the physiological parameter is a blood oxygen level, a heart rate, a blood pressure, an ECG, an airway measurement, an acceleration of the subject (e.g., the subject 104), or any other physiological measurement related to the subject. The physiological parameter is, according to some implementations, detected by a sensor. In various examples, the sensor is configured to transmit data indicative of the physiological parameter to the processor (e.g., the processor 128), the external device (e.g., the external device 142), or another medical device.

In some examples, the physiological parameter is an ECG of the subject (e.g., the subject 104). A compression frequency is determined, based on the pressure of the fluid in the bladder over time. In various cases, an artifact associated with the compression frequency is removed from the ECG.

At 604, a condition of the subject is determined, based on removing the artifact. For example, an artifact associated with the compression frequency may be removed from the ECG of the subject. Based on removing the artifact, it may be determined that the subject is experiencing ventricular fibrillation or ventricular tachycardia. In some implementations, removing the artifact may allow for accurate measurement of the physiological parameter. Thus, the condition may be associated with a corrected physiological parameter (e.g., a blood oxygen level, a heart rate, a blood pressure, an ECG, an airway measurement, an acceleration of the subject, or any other physiological measurement related to the subject). For example, it may be determined that the subject is hypoxic or that the subject is conscious and moving.

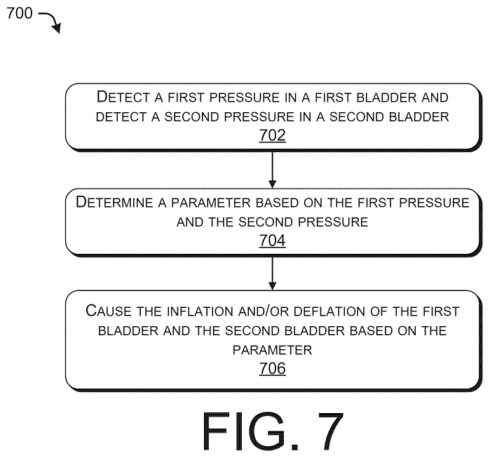

FIG. 7 illustrates an example process for controlling the inflation and deflation of a first bladder and a second bladder based on pressures of the fluid in the first and second bladders. According to various implementations, the first and second bladders (e.g., the first bladder 206 and the second bladder 208) are disposed under the subject (e.g., the subject 204). The process 600 is performed, in various cases, by a trained person (e.g., an emergency medical technician, a physician, a nurse, or the like), a processor (e.g., the processor 128), an external device (e.g., the external device 142), or another medical device (e.g., the mechanical chest compression device 102).

At 702, a first pressure of a fluid in the first bladder and a second pressure of the fluid in the second bladder are detected. In some implementations, the first pressure and the second pressure are detected by one or more pressure sensors (e.g., the first sensor 402 and the second sensor 404). In some examples, the first bladder is a first array of bladders, and the second bladder is a second array of bladders. Distinct elements in the first array of bladders and the second array of bladders can be inflated separately. In some cases, two or more sensors are disposed on each array of bladders.

At 704, a parameter is determined based on the first pressure and the second pressure. In various cases, the parameter is a weight of the subject (e.g., the subject 204), a position of the subject, a compression frequency, a compression depth, or a compression position.

At 706, the first bladder and/or the second bladder are inflated or deflated, based on the parameter. In some examples, the parameter is a first position of the subject (e.g., the subject 204). It may be determined that the subject is disproportionately supported by the first bladder (e.g., the first bladder 206) and identify a second position where the subject is supported by the first bladder and the second bladder (e.g., the first bladder 206 and the second bladder 208) equally. A third pressure for the first bladder and a fourth pressure for the second bladder are determined to move the subject to the second position. For example, a processor (e.g., the processor 128) may determine that the third pressure for the first bladder is greater than the fourth pressure for the second bladder, allowing the subject to move towards the second bladder. Upon detecting that the subject is equally supported by the first bladder and the second bladder, the processor may equalize the pressure in the first bladder and the second bladder.

In some implementations, distinct elements in the first array of bladders and/or the second array of bladders are inflated or deflated, based on the parameter. Sensors (e.g., the first sensor 402 or the second sensor 404) may be disposed on distinct elements in the first array of bladders and the second array of bladders. In some examples, a first position of the subject (e.g., the subject 204) may be determined based on the pressures detected by the sensors. In various cases, a processor (e.g., the processor 128) may be configured to determine the first position of the subject. The processor may be configured to determine whether a center of gravity of the subject is askew from a center line of the backboard (e.g., the backboard 106) including the first array of bladders and the second array of bladders. In response to determining that the center of gravity of the subject is askew from the center line of the backboard, the processor causes, in various instances, the inflation system to change the pressure in the arrays to move the subject to a second position. For example, the processor may determine that a first pressure of the first array of bladders is lower than a second pressure of the second array of bladders. The processor may determine that the subject is disproportionately supported by the second array of bladders. In some instances, the processor causes the inflation system to deflate the first array of bladders and inflate the second array of bladders. In response to causing the inflation system to deflate the first array of bladders and inflate the second array of bladders, the processor is, in various examples, configured to cause the inflation system to inflate the first array of bladders. In some cases, the processor causes the inflation system to inflate the second array of bladders in response to determining that the subject has moved. For example, the processor may determine that the second pressure in the second array of bladders has reduced, indicating that the center of gravity of the subject has moved towards the center line of the backboard. In response to determining that the subject has moved, the processor, in some cases, causes the inflation system to inflate the second array of bladders. In some cases, the processor causes the inflation system to inflate and/or deflate the first subset of the bladders and/or the second subset of the bladders to move the subject.

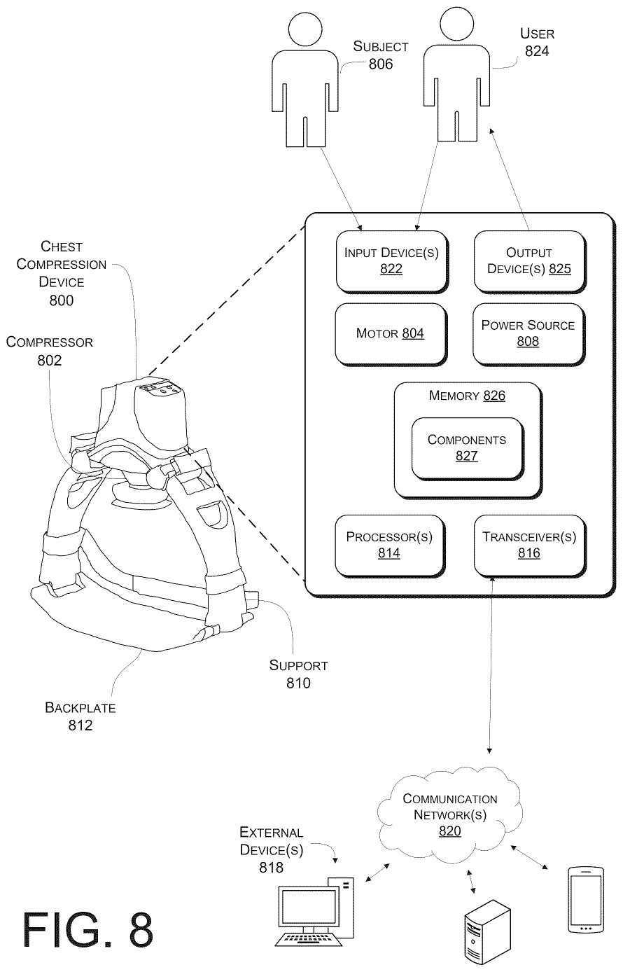

FIG. 8 illustrates a chest compression device 800 configured to perform various functions described herein. For example, the chest compression device 800 is the mechanical chest compression device 102 described in FIG. 1.

In various implementations, the chest compression device 800 includes a compressor 802 that is operatively coupled to a motor 804. The compressor 802 physically administers a force to the chest of a subject 806 that compresses the chest of the subject 806. In some examples, the compressor 802 includes at least one piston that periodically moves between two positions (e.g., a compressed position and a release position) at a compression frequency. For example, when the piston is positioned on the chest of the subject 806, the piston compresses the chest when the piston is moved into the compressed position. A suction cup may be positioned on a tip of the piston, such that the suction cup contacts the chest of the subject 806 during operation. In various cases, the compressor 802 includes a band that periodically tightens to a first tension and loosens to a second tension at a compression frequency. For instance, when the band is disposed around the chest of the subject 806, the band compresses the chest when the band tightens.

The motor 804 is configured to convert electrical energy stored in a power source 808 into mechanical energy that moves and/or tightens the compressor 802, thereby causing the compressor 802 to administer the force to the chest of the subject 806. In various implementations, the power source 808 is portable. For instance, the power source 808 includes at least one rechargeable (e.g., lithium-ion) battery. In some cases, the power source Y08 supplies electrical energy to one or more elements of the chest compression device 800 described herein.

In various cases, the chest compression device 800 includes a support 810 that is physically coupled to the compressor 802, such that the compressor 802 maintains a position relative to the subject 806 during operation. In some implementations, the support 810 is physically coupled to a backboard (e.g., the backboard 106), a backplate 812, cot, or other external structure with a fixed position relative to the subject 806. According to some cases, the support 810 is physically coupled to a portion of the subject 806, such as wrists of the subject 806.

The operation of the chest compression device 800 may be controlled by at least one processor 814. In various implementations, the motor 806 is communicatively coupled to the processor(s) 814. Specifically, the processor(s) 814 is configured to output a control signal to the motor 806 that causes the motor 806 to actuate the compressor 802. For instance, the motor 806 causes the compressor 802 to administer the compressions to the subject 806 based on the control signal. In some cases, the control signal indicates one or more treatment parameters of the compressions. Examples of treatment parameters include a frequency, timing, depth, force, position, velocity, and acceleration of the compressor 802 administering the compressions. According to various cases, the control signal causes the motor 806 to cease compressions.

In various implementations, the chest compression device 800 includes at least one transceiver 816 configured to communicate with at least one external device 818 over one or more communication networks 820. Any communication network described herein can be included in the communication network(s) 820 illustrated in FIG. 8. The external device(s) 818, for example, includes at least one of an external device (e.g., the external device 142), a monitor-defibrillator, an AED, an ECMO device, a ventilation device, a patient monitor, a mobile phone, a server, or a computing device. In some implementations, the transceiver(s) 816 is configured to communicate with the external device(s) 818 by transmitting and/or receiving signals wirelessly. For example, the transceiver(s) 816 includes a NIC, a network adapter, a LAN adapter, or a physical, virtual, or logical address to connect to the various external devices and/or systems. In various examples, the transceiver(s) 816 includes any sort of wireless transceivers capable of engaging in wireless communication (e.g., RF communication). For example, the communication network(s) 820 includes one or more wireless networks that include a 3GPP network, such as an LTE RAN (e.g., over one or more LTE bands), an NR RAN (e.g., over one or more NR bands), or a combination thereof. In some cases, the transceiver(s) 816 includes other wireless modems, such as a modem for engaging in WI-FI®, WIGIG®, WIMAX®, BLUETOOTH®, or infrared communication over the communication network(s) 820. The signals, in various cases, encode data in the form of data packets, datagrams, or the like. In some cases, the signals are transmitted as compressions are being administered by the chest compression device 800 (e.g., for real-time feedback by the external device(s) 818), after compressions are administered by the chest compression device 800 (e.g., for post-event review at the external device 818), or a combination thereof.

In various cases, the processor(s) 814 generates the control signal based on data encoded in the signals received from the external device(s) 818. For example, the external device(s) 818 is the external device 142 described in FIG. 1. For instance, the signals include an instruction to initiate the compressions, and the processor(s) 814 instructs the motor 806 to begin actuating the compressor 802 in accordance with the signals.

In some cases, the chest compression device 800 includes at least one input device 822. In various examples, the input device(s) 822 is configured to receive an input signal from a user 824, who may be a rescuer treating the subject 806. For example, the user 824 is the user 132 described in FIG. 1. Examples of the input device(s) 822 include, for instance, at a keypad, a cursor control, a touch-sensitive display, a voice input device (e.g., a microphone), a haptic feedback device (e.g., a gyroscope), or any combination thereof. In various implementations, the processor(s) 814 generate the control signal based on the input signal. For instance, the processor(s) 814 generate the control signal to adjust a frequency of the compressions based on the chest compression device 800 detecting a selection by the user 824 of a user interface element displayed on a touchscreen or detecting the user 824 pressing a button integrated with an external housing of the chest compression device 800.

According to some examples, the input device(s) 822 include one or more sensors. The sensor(s), for example, is configured to detect a physiological parameter of the subject 806. In some implementations, the sensor(s) is configured to detect a state parameter of the chest compression device 800, such as a position of the compressor 802 with respect to the subject 806 or the backplate 812, a force administered by the compressor 802 on the subject 806, a force administered onto the backboard (e.g., the backboard 106) or the backplate 812 by the body of the subject 806 during a compression, or the like. According to some implementations, the signals transmitted by the transceiver(s) 816 indicate the physiological parameter(s) and/or the state parameter(s).

The chest compression device 800 further includes at least one output device 825, in various implementations. Examples of the output device(s) 825 include, for instance, least one of a display (e.g., a projector, an LED screen, etc.), a speaker, a haptic output device, a printer, or any combination thereof. In some implementations, the output device(s) 825 include a screen configured to display various parameters detected by and/or reported to the chest compression device 800, a charge level of the power source 808, a timer indicating a time since compressions were initiated or paused, and other relevant information.

The chest compression device 800 further includes memory 826. In various implementations, the memory 826 is volatile (such as random access memory (RAM)), non-volatile (such as read only memory (ROM), flash memory, etc.) or some combination of the two. The memory 826 stores components 827, such as instructions that, when executed by the processor(s) 814, causes the processor(s) 814 to perform various operations. In various examples, the components 827 include methods, threads, processes, applications, objects, modules, any other sort of executable instruction, or a combination thereof. In some cases, the components 827 include files, databases, or a combination thereof. In some examples, the memory 826 includes, but is not limited to, RAM, ROM, EEPROM, flash memory, or any other memory technology. In some examples, the memory 826 includes one or more of CD-ROMs, DVDs, CAM, or other optical storage, magnetic cassettes, magnetic tape, magnetic disk storage or other magnetic storage devices, or any other medium which can be used to store the desired information. In various cases, the components 827 cause the processor(s) 814 to perform various functions. In various cases, the memory 826 stores one or more parameters that are detected by the chest compression device 800 and/or reported to the chest compression device 800.

In implementations of the present disclosure, the memory 826 also stores instructions for executing outputting a control signal indicating a compression frequency, a compression depth, or a compression position of the compressor 802. In some examples, the control signal is based on a pressure of a fluid in a bladder (e.g., the first bladder 112, the first bladder 206, or the second bladder 208). In some cases, the memory Y26 stores instructions for executing transmitting data indicative of a compression parameter (e.g., a compression frequency, a compression depth, or a compression position) to an external device (e.g., the external device 142).

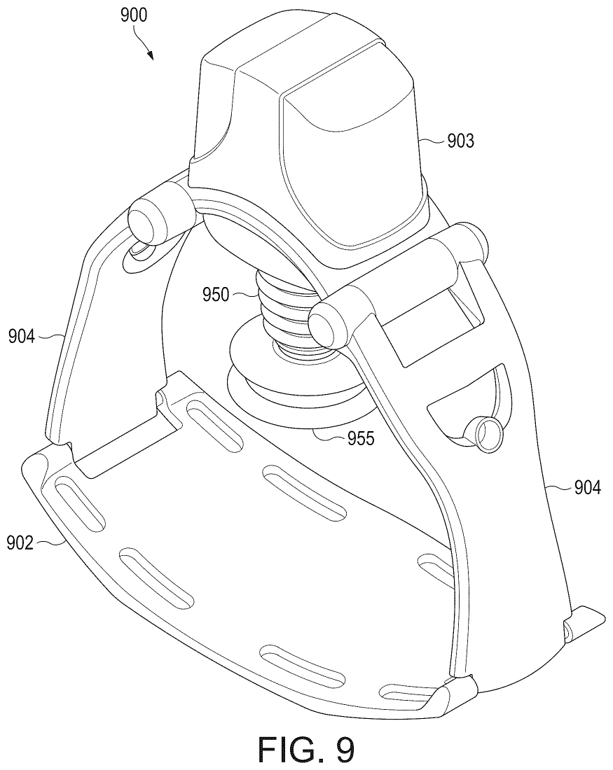

FIG. 9 is a perspective view showing portions of a CPR device 900, according to configurations. As illustrated in FIG. 9, a CPR device 900 may include a backboard 902, a chest compression mechanism 903, and a support leg 904.

The chest compression mechanism 903 may be configured to deliver CPR chest compressions to a patient, as previously described with regard to the configurations illustrated in FIGS. 1-8. The chest compression mechanism 903 may include, for example, a motor-driver piston 950 configured to contact the patient's chest to provide the CPR chest compressions, the motor-driven piston 950 further including a suction cup 955 to attach to the chest of a patient in some configurations.

The support leg 904 is configured to support the chest compression mechanism 903 at a distance from the backboard 902. For example, if the backboard 902 is underneath the patient, who is lying on the patient's back, then the support leg 904 supports the chest compression mechanism 903 at a sufficient distance over the backboard 902 to allow the patient to lay within a space between the backboard 902 and the chest compression mechanism 903, while positioning the chest compression mechanism 903 over the patient's chest.

In configurations, there are two support legs 904. In configurations, the two support legs 904 together form an arch to support the chest compression mechanism 903. An example of such a configuration is illustrated in FIG. 9. As will be understood by one skilled in the art, the mechanical CPR device 900 may include additional components not shown in FIG. 9.

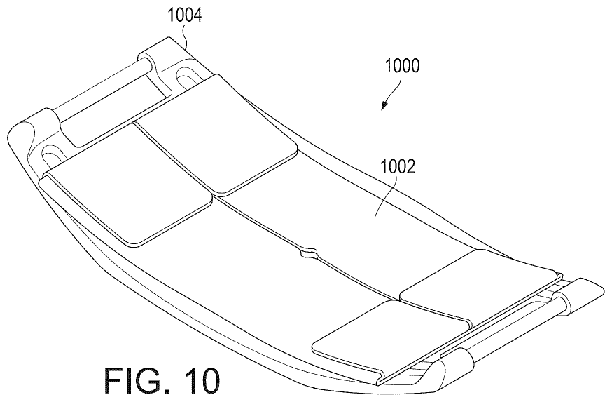

FIG. 10 shows a backboard 1000 having an inflatable portion 1002, according to configurations of the disclosure. Backboard 1000 has a substantially rigid backplate 1004 and an inflatable portion 1002 coupled with the backplate 1004. For the purposes of this disclosure, “substantially rigid” means largely or essentially stiff and not pliant, without requiring perfect inflexibility. In some configurations, backplate 1004 is formed of a substantially rigid plastic, for example. In this way, backplate 1004 is structured to be placed underneath a patient laying supine and support the patient's back during performance of CPR compressions with a mechanical CPR device, such as the example illustrated in FIG. 9. FIG. 10 shows inflatable portion 1002 of backboard 1000 in a folded position, where inflatable portion 1002 is not inflated and is folded onto backplate 1004. However, as will be described further below, inflatable portion 1002 is structured to also be positionable in an unfolded position, extending away from backplate 1004.

In the folded position, inflatable portion 1002 lays substantially flat onto backplate 1004. As used herein, “substantially flat” means largely or essentially flat, without requiring perfect flatness. Additionally, when in the folded position, the folded footprint of inflatable portion 1002 is no larger than the footprint of backplate 1004. That is, inflatable portion 1002 does not extend beyond the perimeter backplate 1004; rather, inflatable portion 1002 fits within the perimeter of backplate 1004 when folded.

Because inflatable portion 1002 fits within the footprint of backplate 1004 in the folded position, backboard 1000 can be easily stored and transported without taking up the extent of space required to accommodate inflatable portion 1002 when it is unfolded and fully inflated.

Additionally, because inflatable portion 1002 folds substantially flat onto backplate 1004, and because backplate 1004 is substantially rigid, backboard 1000 is thus fully operable and can support the patient's back with backplate 1004 when inflatable portion 1002 is in the folded position. Put differently, backboard 1000 is operable for supporting a patient's back whether or not inflatable portion 1002 is deployed.

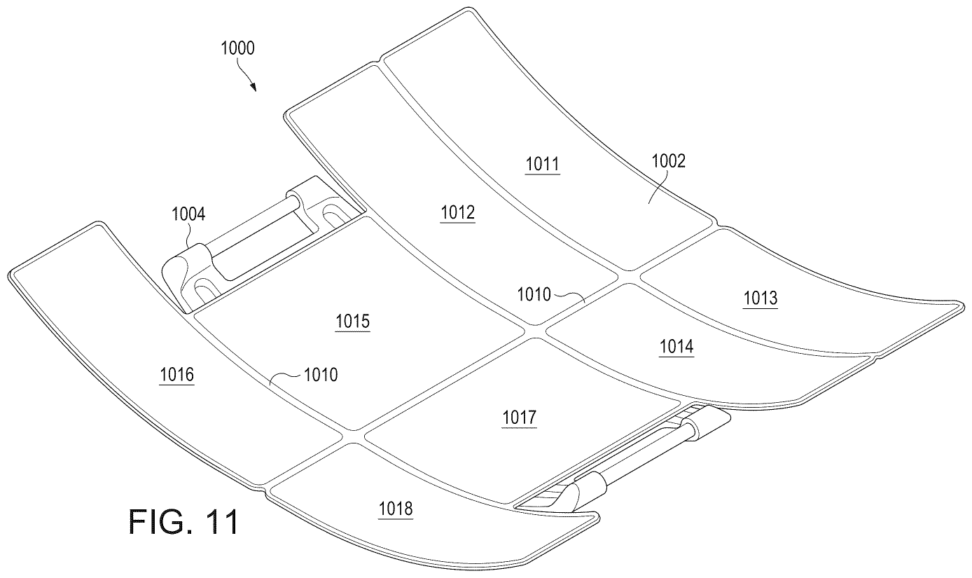

FIG. 11 shows backboard 1000 with inflatable portion 1002 in an unfolded position, but not inflated. When in the unfolded position, inflatable portion 1002 extends beyond the footprint of backplate 1004. As will be described further below, inflatable portion 1002 extends such that inflatable portion 1002 interfaces with a patient's shoulders, arms, upper abdomen, and lower abdomen. That is, when inflatable portion 1002 is unfolded and a patient lays supine on backboard 1000, inflatable portion 1002 contacts portions of the patient's body ranging from the shoulders down to the lower abdomen.

As best illustrated in FIG. 11, inflatable portion 1002 is formed of several inflatable chambers separated by seams 1010. In configurations such as the example shown in FIG. 11, inflatable portion 1002 has eight chambers: first chamber 1011, second chamber 1012, third chamber 1013, fourth chamber 1014, fifth chamber 1015, sixth chamber 1016, seventh chamber 1017, and eighth chamber 1018. It should be noted, however, that in still other configurations, inflatable portion 1002 may be formed of a greater or fewer number of inflatable chambers. Additionally, one skilled in the art will understand that the naming conventions used herein—identifying particular chambers with particular numbers—are used for convenience and clarity and are not intended to be limiting. The described backboard 1000 may have a number of orientations in implementation, and thus the functions of backboard 1000 should not be understood as being limited to particular orientations and numerical designations used in this disclosure.

As mentioned, each of the chambers of inflatable portion 1002 are separated by seams 1010, which join the chambers to form a structurally unitary inflatable portion 1002. More specifically, in some configurations, inflatable portion 1002 is formed from two stacked layers of a substantially flexible material, such as polyurethane, polyvinyl chloride (PVC), polyester, or other suitable material. As used in this disclosure, “substantially flexible” means largely or essentially pliable, without requiring perfect pliability across the whole of inflatable portion 1002. Each layer of the substantially flexible material may be adhered, fused, or otherwise joined together to form seams 1010 dividing inflatable portion 1002 into several chambers and surrounding the perimeter of inflatable portion 1002 to ensure inflatable portion 1002 does not leak. With seams 1010 formed in this way, fluid can be pumped to inflate each of the chambers of inflatable portion 1002, the fluid occupying the space between each layer of substantially flexible material that is not adhered, fused, or otherwise joined.

In configurations, seams 1010 are structured to allow some fluid to travel between each of the chambers, such that the chambers can be inflatable simultaneously. In still other configurations, seams 1010 are structured to entirely prevent the flow of fluid between chambers, such that each chamber is inflated individually. Additionally, inflatable portion 1002 of backboard 1000 can be inflated according to any of the means described above with regard to the example inflatable backboard of FIG. 1. That is, a controller or processor is implemented, in configurations, to control inflation of inflatable portion 1002 with fluid, such as gaseous nitrogen or carbon dioxide, stored in an airtight vessel. However, in still other configurations, inflatable portion 1002 is configured to be inflated manually by a rescuer.

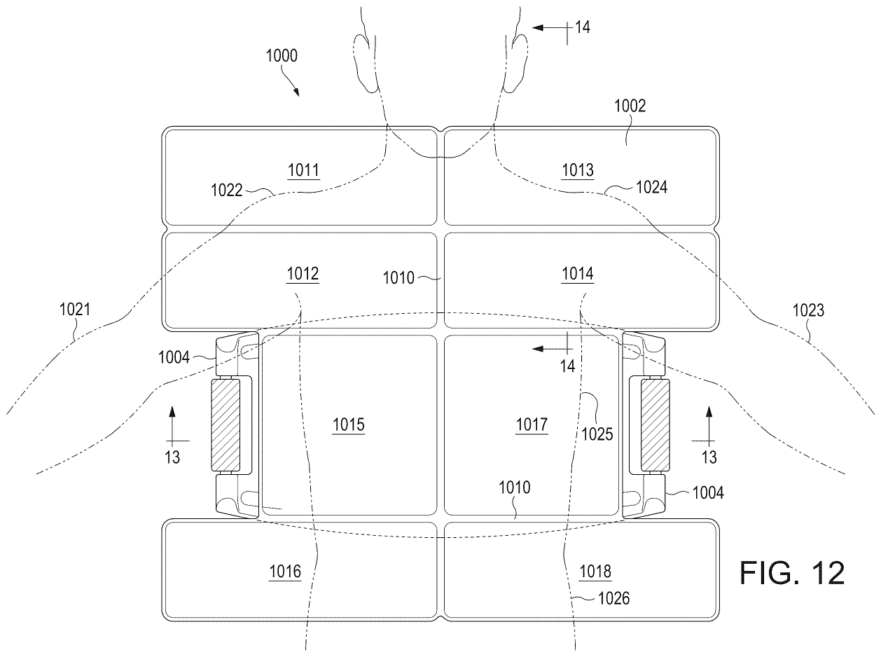

FIG. 12 shows a top view of backboard 1000 with a representation of a patient 1020 received on backboard 1000. Specifically, patient 1020 is shown as laying supine on backboard 1000, with backplate 1004 and inflatable portion 1002 contacting and supporting the back of the patient 1020. As illustrated in FIG. 12, each chamber of inflatable portion 1002 is structured to support a portion of the patient's body. Each of the chambers and their support functions relative to the patient's body will be described in turn.

First chamber 1011, as shown, extends away from backplate 1004 such that it is positioned to contact an upper portion of the patient's first arm 1021 and the patient's shoulder 1022. For purposes of this disclosure, upper portions of the patient's body refer to those portions nearest the patient's head and may also be referred to herein as top sides. Accordingly, lower portions, or undersides, refer to those portions nearest the patient's feet. Additionally, although FIG. 12 shows the first arm 1021 as being the patient's right arm, it should be understood that first chamber 1011 is not orientationally limited in this way. Because first chamber 1011 is designated for clarity and convenience, one skilled in the art will understand that in still other configurations, a chamber contacting the patient's left arm may considered a first chamber.

As mentioned, first chamber 1011 contacts an upper portion of a first arm 1021, as well as the patient's shoulder 1022. In addition, second chamber 1012 extends away from backboard 1000 such that it contacts a lower portion, or underside, of the first arm 1021, as well as a side of the patient 1020. When first chamber 1011 and second chamber 1012 are inflated, then, first chamber 1011 fits snugly against the shoulder 1022 and top side of the patient's first arm 1021, while second chamber 1012 fits snugly against the underside of the patient's first arm 1021 and the side of the patient 1020. In this way, first chamber 1011 and second chamber 1012 work in conjunction to maintain the patient's position and prevent drifting of the patient in a direction toward the patient's head or toward the patient's feet. Particularly, first chamber 1011 tends to counter any movement toward the patient's head, while second chamber 1012 tends to counter any movement toward the patient's feet, and thus first chamber 1011 and second chamber 1012 work together to maintain the patient's upper body in one position.

Third chamber 1013 and fourth chamber 1014 are positioned on an opposite side of patient 1020 but are similar in function to first chamber 1011 and second chamber 1012. Particularly, similar to first chamber 1011, third chamber 1013 extends away from backboard 1000 such that it is positioned to contact an upper portion of the patient's second arm 1023 and the patient's second shoulder 1024. Fourth chamber 1014 extends away from backplate 1004 such that it contacts a lower portion, or underside, of the second arm 1023, as well as a side of the patient 1020. When third chamber 1013 and fourth chamber 1014 are inflated, third chamber 1013 thus fits snugly against the second shoulder 1024 and the top side of the patient's second arm 1023.

Inflating the first chamber 1011, second chamber 1012, third chamber 1013, and fourth chamber 1014 thus maintains the position of the patient's entire upper body and prevents the patient's upper body from drifting. More specifically, the combination of first chamber 1011 and second chamber 1012 supporting the patient's first arm 1021 and first shoulder 1022 with the third chamber 1013 and fourth chamber 1014 supporting the patient's second arm 1023 and second shoulder 1024 pins both of the patient's arms and shoulders in place. Pinning the arms and shoulders on both sides of the patient's body and countering any movements toward the patient's head and the patient's feet, in this way, keeps the patient's upper body in an optimal position for receiving compressions.

Fifth chamber 1015, as shown in FIG. 12, is positioned such that it contacts the patient's upper abdomen 1025 on a first side of the patient. FIG. 12 shows fifth chamber 1015 contacting the upper abdomen 1025 on the patient's right side, but as previously mentioned, configurations of backboard 1000 are not orientationally limited. Accordingly, in still other configurations, fifth chamber 1015 may be understood as contacting the upper abdomen 1025 on the patient's left side. Additionally, fifth chamber 1015 fits within the footprint of backplate 1004 when inflated. Put differently, when inflated, fifth chamber 1015 does not extend away from backplate 1004; rather, fifth chamber 1015 inflates such that it rests directly on top of backplate 1004.

Sixth chamber 1016, conversely, extends away from backplate 1004 toward the patient's feet, such that it is positioned to contact the patient's lower abdomen 1026. More particularly, sixth chamber 1016, when inflated, contacts the patient's lower abdomen 1026 on a side of the patient's body corresponding to fifth chamber 1015. In configurations such as the one illustrated in FIG. 12, sixth chamber 1016 thus contacts the lower abdomen 1026 on the patient's right side. However, in still other configurations, sixth chamber 1016 contacts the patient's left side, as the described chambers are not orientationally limited.

When fifth chamber 1015 and sixth chamber 1016 are both inflated, fifth chamber 1015 fits snugly against the upper abdomen 1025 of the patient, while sixth chamber 1016 fits snugly against the lower abdomen 1026. In this way, fifth chamber 1015 and sixth chamber 1016 work in conjunction to maintain the position of the patient's abdomen and prevent the patient from drifting toward the patient's head or feet. Fifth chamber 1015 tends to counter any movement toward the patient's head, while sixth chamber 1016 tends to counter any movement toward the patient's feet, and thus fifth chamber 1015 and sixth chamber 1016 maintain the position of the patient's abdomen during treatment.

Seventh chamber 1017 and eighth chamber 1018 are positioned on an opposite side of patient 1020 but are similar in function to fifth chamber 1015 and sixth chamber 1016. In particular, seventh chamber 1017 fits within the footprint of backplate 1004 when fully inflated, contacting and supporting the patient's upper abdomen 1025 on a side opposite fifth chamber 1015. Eighth chamber 1018, conversely, extends away from backplate 1004 such that it contacts and supports the patient's lower abdomen 1025 on a side opposite sixth chamber 1016. Accordingly, when seventh chamber 1017 and eighth chamber 1018 are inflated, seventh chamber 1017 fits snugly against the patient's upper abdomen 1025, and eighth chamber 1018 fits snugly against the patient's lower abdomen 1026.

Inflating the fifth chamber 1015, sixth chamber 1016, seventh chamber 1017, and eighth chamber 1018 thus maintains the position of the patient's entire abdomen and prevents the patient's abdomen from drifting. The combination of chambers contacting and supporting various portions of the patient's abdomen—and countering movement toward each chamber—pins the patient's abdomen in place, keeping the patient's abdomen in an optimal position for receiving compressions. Furthermore, in combination with first chamber 1011, second chamber 1012, third chamber 1013, and fourth chamber 1014, described above, the patient's entire upper body and abdomen are supported such that the patient's body is maintained in the optimal compression position.

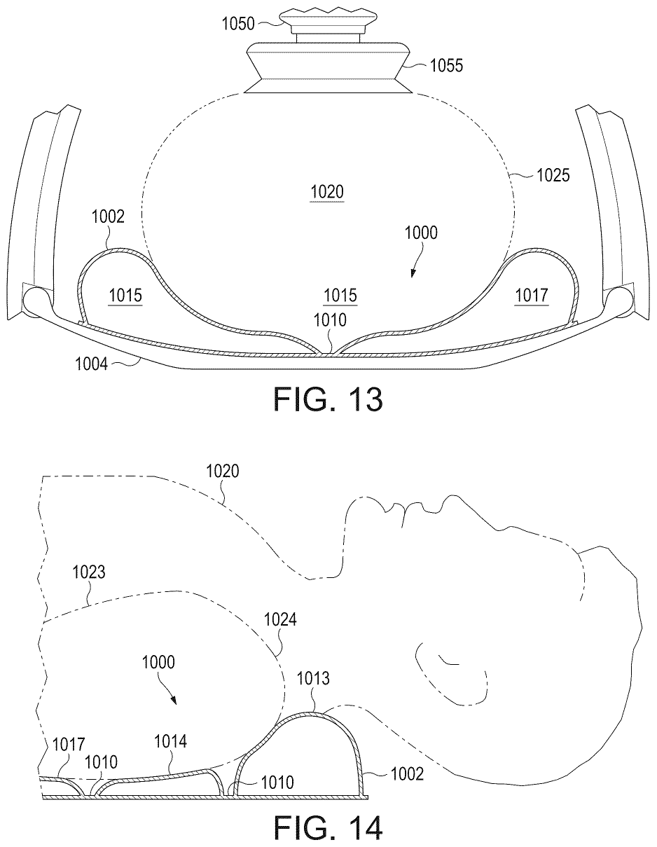

FIGS. 13-14 show cross-sectional views of inflatable portion 1002 of backboard 1000. Specifically, FIG. 13 shows front elevational view of portions of a CPR device, such as the example shown in FIG. 9, with some portions of the CPR device and the representation of a patient 1020 being hidden. As shown, when a patient 1020 is received in the CPR device and lays supine on backboard 1000, the patient's upper abdomen 1025 is snugly supported by fifth chamber 1015 and seventh chamber 1017. In particular, because of their inflatable and flexible nature, fifth chamber 1015 and seventh chamber 1017 deform to receive the patient's upper abdomen 1025, with the fluid filling each chamber tending to concentrate at portions of the chamber that are not beneath the weight of patient 1020.

Fluid gathering in these portions allows for fifth chamber 1015 and seventh chamber 1017 to maintain the position of the patient. For instance, if patient 1020 were to drift away from seventh chamber 1017 and toward fifth chamber 1015, the pressure within fifth chamber 1015 would cause fifth chamber 1015 to act on patient 1020 and counter the movement of patient 1020, maintaining patient 1020 between fifth chamber 1015 and seventh chamber 1017.

Similarly, FIG. 14 shows a section of inflatable portion 1002 viewed from the side. In particular, FIG. 14 shows a patient 1020 received on inflatable portion 1002 viewed from the patient's left side, with the patient's second arm 1023 and second shoulder 1024 being maintained in position by third chamber 1013 and fourth chamber 1014. As previously mentioned, third chamber 1013 is structured to fit snugly against the patient's second shoulder 1024, and just as discussed with regard to FIG. 13, third chamber 1013 is shown in FIG. 14 as deforming based on the position of the patient's second shoulder 1024. Fluid filling third chamber 1013 concentrates where third chamber 1013 is not directly beneath the weight of patient 1020, and thus, if patient 1020 were to drift in a direction toward the patient's head, the pressure within third chamber 1013 would cause third chamber 1013 to act on patient 1020 and counter the movement. Consequently, the second arm 1023 and second shoulder 1024 can be maintained in an optimal position.

As previously mentioned, in some configurations, backboard 1000 is implemented with a mechanical CPR device, and a controller or microprocessor of the mechanical CPR device controls inflation of inflatable portion 1002. Specifically, one or more pressure sensors may be implemented to monitor the pressure of each inflatable chamber, and the controller or microprocessor of the mechanical CPR device controls the internal pressure of each inflatable chamber of inflatable portion 1002 by regulating the amount of fluid, such as gaseous nitrogen or carbon dioxide, in each chamber.

For instance, when backboard 1000 is implemented with a mechanical CPR device to deliver CPR compressions to a patient's chest, the patient's body may tend to drift from its initial location. If the patient's body drifts in a direction toward the patient's head, the patient's first shoulder 1022 will press against first chamber 1011 and cause it to deform, changing the pressure of first chamber 1011 read by a pressure sensor. The controller or processor of the mechanical CPR device, in configurations, then receives this change in pressure and further inflates first chamber 1011 with more fluid to counter the patient's movement against first chamber 1011. Similarly, if the patient's body drifts in a direction toward the patient's feet, the underside of patient's first arm 1021 will press against second chamber 1012, and the controller may further inflate second chamber 1012 with more fluid to counter the movement against second chamber 1012.

In configurations implementing one or more pressure sensors and a controller configured to regulate the amount of fluid in each inflatable chamber, the controller may adjust the volume of each chamber throughout performance of compressions to maintain the patient's body in an optimal position for receiving compressions. Consequently, the pressure and volume of each of the first chamber 1011, second chamber 1012, third chamber 1013, fourth chamber 1014, fifth chamber 1015, sixth chamber 1016, seventh chamber 1017, and eighth chamber 1018 may be adjusted throughout treatment, depending on the movement of the patient.

For example, in configurations, the pressure and volume of each of the first chamber 1011 and second chamber 1012 are controlled to adjust the position of the patient. Specifically, first chamber 1011 and second chamber 1012 can be inflated more than the remaining chambers, causing the first side of the patient to lift higher than the second side of patient. Lifting the first side of the patient in this way may provide a lateral adjustment or compensation to maintain the patient's body in the optimal position for receiving compressions. Additionally or alternatively, the pressure and volume of each of the first chamber 1011 and third chamber 1013 can be controlled, in configurations, to be inflated more than the remaining chambers. Inflating first chamber 1011 and third chamber 1013 in this way causes a portion of the patient's body nearest the patient's head to lift more than other portions of the body, providing an adjustment or compensation in the direction toward the patient's feet to maintain the patient's body in the optimal position for receiving compressions.

Although combinations for controlling the pressures and volumes of the inflatable chambers have been thus far described with regard to the first chamber 1011, second chamber 1012, and third chamber 1013, one skilled in the art will understand that a variety of adjustments to the patient's body position are possible by controlling any individual chamber or combination of chambers.

In further configurations of the disclosure, a patient's position within a mechanical CPR device is adjustable. Put differently, not only are configurations of the disclosure directed to maintaining the patient's body in a single, optimal compression position, but still other configurations are directed to adjusting the patient's body to adjust the location of compressions. Laterally adjusting the compression location, specifically, may be beneficial in some instances because the heart is not centered in the rib cage. Accordingly, in some situations, more directly targeting the heart may benefit blood flow during performance of CPR.

FIG. 15 shows an embodiment of a backboard 1500 configured to adjust the position of a patient laying supine, according to configurations of the disclosure. As shown, backboard 1500 has a rigid backplate 1504 configured to receive the patient laying supine. Backboard 1500 also includes a first wedge 1510 and a second wedge 1520. FIG. 15 shows the first wedge 1510 and second wedge 1520 in a first position, where each wedge lays flat against backplate 1504. As will be described in further detail below, each of the first wedge 1510 and second wedge 1520 is adjustable, in configurations, to change the position of the patient laying on backboard 1500 by lifting the first wedge 1510 and second wedge 1520 from this first, flat position.

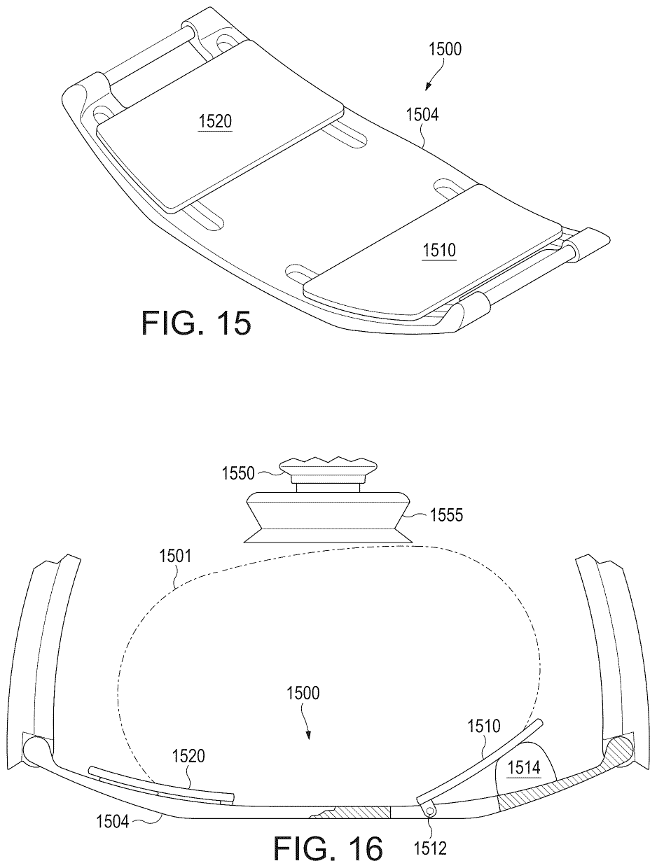

For instance, FIG. 16 shows backboard 1500 with first wedge 1510 in a lifted position and second wedge 1520 still in the flat position. Because second wedge 1520 is in the flat position, second wedge 1520 largely follows the surface of backplate 1504. However, because first wedge 1510 is in the lifted position, surface of backboard 1500 receiving patient 1501 does not follow the surface of backplate 1504 at first wedge 1510. Rather, first wedge 1510 acts to lift patient 1501 and laterally adjust the location on patient 1501 at which compressions are delivered by piston 1550 and suction cup 1555, in configurations.

In some configurations, first wedge 1510 is coupled with backplate 1504 with a hinge 1512. Hinge 1512 is fixed to backplate 1504 such that first wedge 1510 may rotate about hinge 1512 to move from the flat position to lifted positions at various heights above backplate 1504. Additionally, in configurations, an inflatable bulb 1514 is implemented to lift first wedge 1510 above the flat position to the lifted position. When inflatable bulb 1514 is deflated, first wedge 1510 lays in the flat position against backplate 1504. When inflatable bulb 1514 is inflated, first wedge is forced away from backplate 1504, rotating about hinge 1512 to reach a lifted position such as the one shown in FIG. 16.

In some configurations, a controller or processor of the mechanical CPR device first wedge 1510 is implemented with is configured to control inflation and deflation of inflatable bulb 1514. That is, the controller or processor controls an amount of fluid within inflatable bulb 1514. In configurations, the fluid used to inflate inflatable bulb 1514 is a gas, such as carbon dioxide or nitrogen, and the controller or processor of the mechanical CPR device determines an amount of gas to transmit from a storage vessel to inflatable bulb 1514 to cause first wedge 1510 to lift a desired amount. In configurations, the amount of fluid used to inflate inflatable bulb 1514 varies based on a desired lateral adjustment of the compression location. Put differently, first wedge 1510 can be lifted to varying heights to move the compression location through various points on the patient's chest.

Furthermore, although FIG. 16 shows only first wedge 1510 in the lifted position, one skilled in the art will understand that second wedge 1520 functions the same as first wedge 1510. In this way, second wedge 1520 is also fixed to backplate 1504 at a hinge, and second wedge 1520 is also structured to lift from backplate 1504 to varying heights. In configurations, the height of second wedge 1520 is adjustable via an inflatable bulb 1514, just as described above with regard to first wedge 1510.

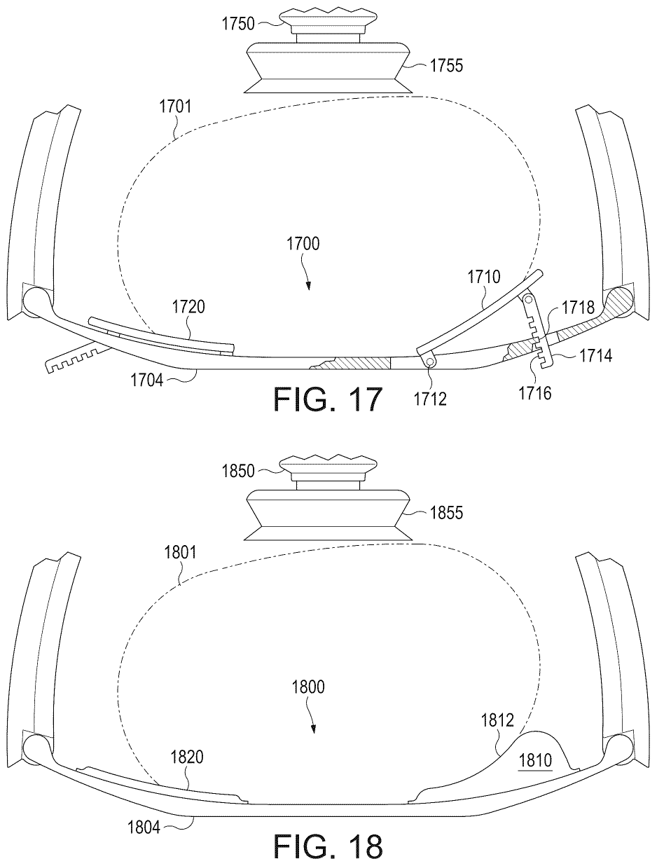

FIG. 17 shows a backboard 1700 configured to adjust the position of a patient laying supine, according to an additional configuration. Similar to the example configuration described with regard to FIGS. 15-16, backboard 1700 has a rigid backplate 1704 configured to receive the patient laying supine. Backboard 1700 also has a first wedge 1710 and a second wedge 1720. FIG. 17 shows the first wedge 1710 in a lifted position, while second wedge 1720 is shown in the flat position against backplate 1704. With first wedge 1710 in the lifted position, first wedge 1710 acts to lift patient 1701 and laterally adjust the location on patient 1701 at which piston 1750 and suction cup 1755 deliver compressions, compared with a position where both the first wedge 1710 and second wedge 1720 are flat.

Similar to the configuration shown in FIGS. 15-16, first wedge 1710 is coupled with backplate 1704 with a hinge 1712. Hinge 1712 is fixed to backplate 1704 such that first wedge 1710 may rotate about hinge 1712 to move from the flat position to the lifted position shown in FIG. 17. In configurations such as the example shown in FIG. 17, a rack mechanism is used to adjust the height of first wedge 1710 above backplate 1704. More specifically, a rack 1714 is attached to surface of first wedge 1710 that interfaces with backplate 1704, and rack 1714 passes through an opening in backplate 1704. Rack 1714 has a plurality of teeth 1718, which are structured to catch a tab 1718 on backplate 1704. To position first wedge 1710 a lifted position, first wedge 1710 may be rotated about hinge 1712 to bring rack 1714 through backplate 1704. When first wedge 1710 is lifted to a desirable height, one of teeth 1716 is positioned to catch the tab 1718, securing first wedge 1710 in place.

In configurations, first wedge 1710 is manually adjusted, with a rescuer choosing a desired height of first wedge 1710 by placing one of teeth 1716 over tab 1718. In still other configurations, the adjustment of first wedge 1710 is made automatically, with a controller or processor of the mechanical CPR device driving a motor or other actuator that causes rack 1714 to move. Regardless of the means of adjustment, configurations implementing a rack mechanism such as the example of FIG. 17 allow for first wedge 1710 to be placed at a variety of height, allowing for the compression location to move to various points on the patient's chest. Additionally, although the rack mechanism of FIG. 17 has been described with regard to first wedge 1710, it should be understood that second wedge 1720 also includes a rack and thus may also be height adjustable in the manner just described.

FIG. 18 shows yet another backboard 1800 configured to adjust the position of a patient laying supine, according to configurations. Similar to the example configurations described above with regard to FIGS. 15-17, backboard 1800 has a rigid backplate 1804. Additionally, backboard 1800 has a first adjustment device 1810 and a second adjustment device 1820. FIG. 18 shows the first adjustment device 1810 in a lifted position, while second adjustment device 1820 is shown in the flat position against backplate 1804. With first adjustment device 1810 in the lifted position, first adjustment device 1810 acts to lift patient 1801 and adjust the location on the patient's chest where compressions are delivered by piston 1850 and suction cup 1855.

Different from the wedge examples described above with regard to FIGS. 15-17, first adjustment device 1810 implements an expandable bag 1812. This expandable bag 1812, in configurations, is filled with a material that may either expand or retract. For instance, in some configurations, expandable bag 1812 is filled with a vacuum sealed foam. In such configurations, expandable bag 1812 has a valve that, when opened, causes the vacuum sealed foam to expand. In still other configurations, expandable bag 1812 is filled with air and can be inflated or deflated to adjust the position of patient 1801.

In configurations such as the example shown in FIG. 18, expandable bag 1812 can be adhered to backplate 1804. That is, expandable bag 1812 need not be permanently fixed to backplate 1804. Rather, expandable bag 1812 can be placed on backplate 1804 at the time the patient is being positioned within the mechanical CPR device, or the backplate 1804 may be prepared with expandable bag 1812 already attached. In configurations, expandable bag 1812 has an adhesive surface that allows expandable bag 1812 to be adhered to backplate 1804.

In any of the configurations described above with regard to FIGS. 15-19, the point on the patient's chest where compressions are delivered can be laterally adjusted by lifting one or both sides of the patient to various heights. For instance, if a mechanical CPR device is positioned such that compressions are delivered in the center of the patient's chest, implementing the configurations shown in FIGS. 15-19 allows the compression point to be laterally moved away from the center. In some situations, it may be beneficial to move the compression point closer to the patient's heart to improve blood flow. In still other situations, the topography of a particular patient's chest may require lateral adjustment of the compression point to create a stable connection with the patient's chest, particularly where a suction cup is implemented with the CPR device.

As discussed, configurations of the lateral adjustment devices of FIGS. 15-19 are adjustable to varying heights. In this way, a patient received in a mechanical CPR device implementing any of the example lateral adjustment devices can be placed in multiple positions. When each lateral adjustment device is in the flat position, the patient lays supine in a first position against the rigid backplate, without being lifted off the backplate. In configurations, one lateral adjustment device is lifted to a first height above the rigid backplate, accordingly lifting the patient to a second position. The lateral adjustment device can be further lifted to a second height above the backplate, placing the patient in a third position, and so on. In this way, example configurations of the lateral adjustment devices allow for a range of patient positions, depending on the placement of one or both lateral adjustment devices.

Furthermore, configurations shown in FIGS. 15-19 can provide stability on both sides of a patient. For example, when a mechanical CPR device is used with a smaller patient, such as a child, the adjustment devices of FIGS. 15-19 can be deployed on each side of the CPR device to narrow the space for receiving the patient. In this way, whether or not the adjustment devices are also used to laterally adjust the compression location, the adjustment devices stabilize the patient within a narrower space and reduce the possibility that the patient will drift laterally.

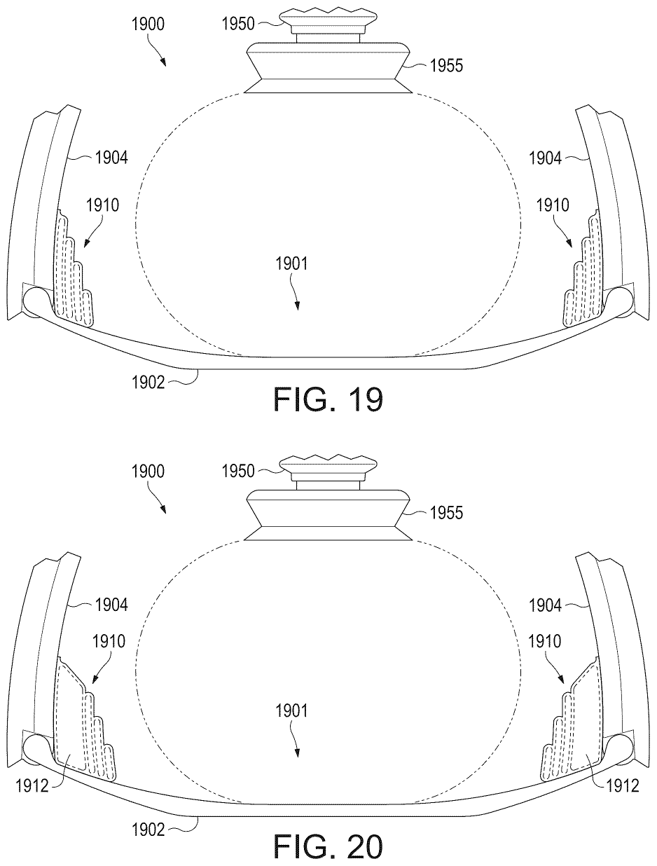

FIG. 19 shows a backboard 1900 with an inflatable portion 1910, according to additional configurations of the disclosed technology. Backboard 1900, as shown, bears similarities to other example backboards implemented with a CPR device that have been discussed. Backboard 1900 has a rigid backplate 1902, and backboard 1900 is implemented with a CPR device having support legs 1904 and a piston 1950 and suction cup 1955 for performing compressions to the chest of a patient 1901. Different from the example backboards described thus far, backboard 1900 has an inflatable portion 1910 configured to inflate from support legs 1904 toward a centerline of the CPR device. For the purposes of this disclosure, the centerline of the CPR device can be understood as being a line coextensive with a long axis of piston 1950.

Accordingly, in configurations implementing backboard 1900 with a CPR device such as the example shown in FIG. 9, inflatable portion 1910 inflates such that it moves from support legs 1904, under patient 1901, and toward the centerline. As shown in FIG. 19, in some configurations, inflatable portion 1910 is actually two portions—one corresponding to each of support legs 1904 forming an arch. However, it should be understood that the two portions of inflatable portion 1910 illustrated in FIG. 19, and discussed herein, are not intended to be limiting. Rather, inflatable portion 1910 is a single portion in still other configurations, and it is configured to inflate from one support leg to the opposite support leg, traveling under patient 1901 along the way.

When inflatable portion 1910 of backboard 1900 is not inflated, in configurations, inflatable portion 1910 fits substantially flat against each of support legs 1904. That is, without inflatable portion 1910 deployed, a patient 1901 can still be received on backplate 1902 to receive CPR treatment without inflatable portion 1910 interfering with the treatment. In still other configurations, backboard 1900 does not include backplate 1902 at all. Rather, the CPR device implementing backboard 1900 is positioned over patient 1901 laying supine on a surface, such as the ground or a gurney, and inflatable portion 1910 is inflated such that it travels underneath patient to provide support. As will be described in further detail below, sequences of inflating inflatable portion 1910 allow for inflatable portion 1910 to travel underneath patient 1901, according to configurations of the disclosed technology.

For example, in configurations of backboard 1900, individual chambers of inflatable portion 1910 are inflated in sequence to cause inflatable portion 1910 to travel from one of support legs 1904 toward the centerline of the CPR device. Referring now to FIG. 20, inflatable portion 1910 is shown as having a first chamber 1912 inflated, with remaining chambers of inflatable portion 1910 not inflated. As illustrated, first chamber 1912 is a chamber of inflatable portion 1910 nearest either of support legs 1904. However, this chamber is designated as a first chamber 1912 for clarity and convenience, and orientational and numerical designations should not be interpreted as limiting. Configurations of inflatable portion 1910 may have any number of individual chambers in implementation, and any individual chamber may be considered a first chamber.

In configurations such as the example shown in FIG. 20, inflating first chamber 1912 first causes inflatable portion 1910 to begin traveling toward the centerline of the CPR device, as first chamber 1912 expands and widens. In this way, the remaining chambers of inflatable portion 1910 move along backplate 1902 toward the centerline before they are inflated. As inflatable portion 1910 travels toward the centerline in this way, the remaining chambers are inflated in sequence to continue the movement of inflatable portion 1910 and cause it to slide under patient 1901.

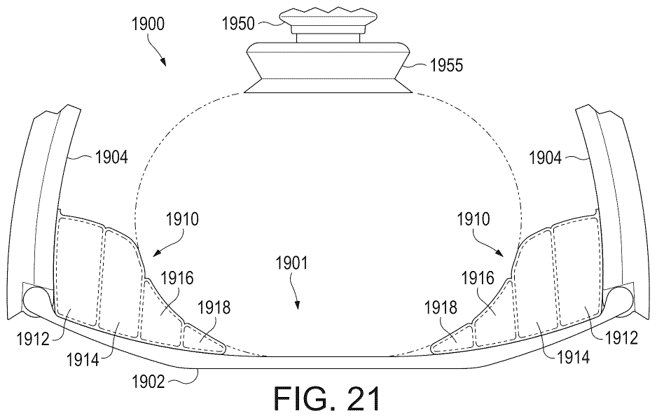

FIG. 21 shows inflatable portion 1910 fully deployed, with each chamber of inflatable portion 1910 inflated and supporting patient 1901. As mentioned, the chambers of inflatable portion 1910 are inflated in sequence to reach the position shown in FIG. 21, in configurations. This means that after first chamber 1912 has been fully inflated, as shown in FIG. 20, second chamber 1914 is then fully inflated. Inflating second chamber 1914 causes inflatable portion 1910 to continue traveling toward the centerline. While second chamber 1914 is being inflated, the remaining chambers—still uninflated—can slide under patient 1901 as they travel toward the centerline. Once second chamber 1914 is fully inflated, third chamber 1916 is then inflated, followed by fourth chamber 1918. When each chamber is fully inflated, inflatable portion 1901 sits between backplate 1902 and the back of patient 1901, providing a supportive surface for patient 1901 when receiving CPR treatment.

Inflatable portion 1910, in configurations, also lifts patient 1901 off backplate 1902. The inflated chambers of inflatable portion 1910, being filled with a fluid such as air, tend to concentrate fluid in locations not directly under the weight of patient 1901. In this way, inflatable portion 1910 provides pressure against patient 1901 to prevent the patient 1901 from drifting during CPR treatment. Specifically, the regions of inflatable portion 1910 interfacing with the sides of patient 1901 counter movement of patient 1901. If patient 1901 begins to drift toward either of support legs 1904, inflatable portion 1910 will provide pressure to counter the movement and cause patient 1901 to return to the centerline of the CPR device.

As previously mentioned, in some configurations, backboard 1900 does not include a rigid backplate 1902 at all. Rather, patient 1901 lays supine on a surface, such as the ground or a gurney, and a CPR device implementing inflatable portion 1910 is positioned over patient 1901. Deploying inflatable portion 1910—in the sequence described above, or in any additional or alternative sequences described herein—causes inflatable portion 1910 to travel under the patient's back and lift patient 1901 from the surface on which they are laying. In this way, inflatable portion 1910 provides a supportive surface that can be easily fitted under patient 1901 without a rescuer needing to maneuver the body of patient 1901.

Additionally, although a sequence has been described thus far where inflatable portion 1910 is inflated in the order of first chamber 1912, second chamber 1914, third chamber 1916, and fourth chamber 1918, still other inflation sequences are possible in additional or alternative configurations. For example, inflatable portion 1910 may instead be inflated in a sequence first inflating fourth chamber 1918, then third chamber 1916, then second chamber 1914, and finally first chamber 1912. Moreover, inflation sequences need not require that one chamber is fully inflated before beginning to inflate another chamber. In a sequence beginning with fourth chamber 1918, for instance, fourth chamber 1918 may be only partially inflated when third chamber 1916 begins inflating, and third chamber 1916 may be only partially inflated when second chamber 1914 begins inflating, and so on.

Furthermore, although FIGS. 19-21 show an example backboard 1900 having four chambers forming inflatable portion 1910, still other configurations of backboard 1900 have a greater or fewer number of individual chambers. One skilled in the art will understand that the illustrated example backboard 1900 and the described inflation sequences for inflatable portion 1910 are not exhaustive.

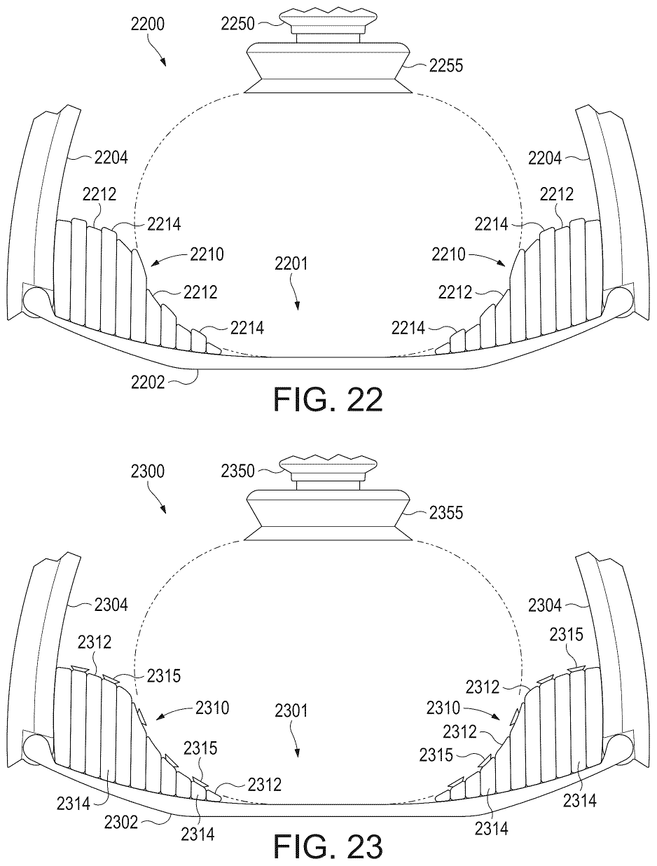

FIG. 22 shows a backboard 2200 with an inflatable portion 2210, according to additional configurations of the disclosure. Backboard 2200, similar to example configurations just discussed with regard to FIGS. 19-21, has a rigid backplate 2202, and backboard 2200 is implemented with a CPR device having support legs 2204 and a piston 2250 and suction cup 2255 for performing compressions to a chest of a patient 2201. Backboard 2200 also has an inflatable portion 2210 configurated to inflate from support legs 2204 to a centerline of the CPR device.

In configurations implementing backboard 2200, inflatable portion 2210 is configured to move from support legs 2204, under patient 2201, and toward the centerline, just as similar to the examples discussed with regard to FIGS. 19-21. Additionally, in some configurations, inflatable portion 2210 is two portions—one corresponding to each of support legs 2204. Nonetheless, in still other configurations, inflatable portion 2210 is a single portion configured to inflate from one support leg to the opposite support leg, and the example configuration showing two portions in FIG. 22 should not be understood as limiting.

Although not shown in FIG. 22, in configurations, when inflatable portion 2210 is not inflated, inflatable portion 2210 fits substantially flat against support legs 2204. Additionally, in some configurations, backboard 2200 does not include a rigid backplate 2202. Instead, in configurations lacking a rigid backplate 2202, inflatable portion 2210 is configured to travel along a surface on which patient 2201 is laying supine, and inflatable portion 2210 is configured to travel between the patient's back and the surface to provide support. As will be described in further detail, sequences of inflating inflatable portion 2210 allow for inflatable portion 2210 to travel underneath patient 2201 and engage the patient's back to lift them from a surface, according to configurations.

The inflatable portion 2210 of backboard 2200, in configurations, is formed of a plurality of low friction chambers 2212 and a plurality of high friction chambers 2214. Low friction chambers 2212 are formed of a substantially flexible material having a coefficient of friction below 0.02, while high friction chambers 2214 are formed of a substantially flexible material having a coefficient of friction ranging from 0.02-1, in configurations. In some configurations, high friction chambers 2214 more preferably have a coefficient of friction in a range of 0.5-1. Because of the varying coefficients of friction, low friction chambers 2212 and high friction chambers 2214 interface with patient 2201 differently. These differences can be utilized to inflate inflatable portion 2210 in particular sequences that allow inflatable portion 2210 to travel underneath patient 2201.

For example, in some configurations, inflatable portion 2210 is deployed by first inflating all low friction chambers 2212, leaving high friction chambers uninflated. With only low friction chambers 2212 inflated, low friction chambers 2212 rise beyond high friction chambers 2214 as inflatable portion moves from support leg 2204 toward the centerline. Accordingly, only the low friction material of low friction chambers 2212 contacts patient 2201, and inflatable portion 2210 is able to slide between patient 2201 and rigid backplate 2202, or other surface. Once low friction chambers 2212 are fully inflated, and inflatable portion 2210 is positioned under patient 2201, the high friction chambers 2214 are inflated. The high friction material of high friction chambers 2214 then engages the patient's back, with minimal slippage, causing patient 2201 to lift off backplate 2202 or other surface. Additionally, as shown in FIG. 22, high friction chambers 2214 are taller than low friction chambers 2212, in configurations. This height difference between high friction chambers 2214 and low friction chambers 2212 allows high friction chambers 2214 to engage the patient's back and lift it off a surface with minimal slippage from low friction chambers 2212.

With inflatable portion 2210 fully deployed, the low friction chambers 2212 and high friction chambers 2214 being filled with a fluid tends to provide pressure against patient 2201 and counter movement of patient 2201 if patient 2201 shifts toward either of support legs 2204. In this way, inflatable portion 2210 provides a supportive surface for patient 2201 that prevents the patient from drifting during CPR treatment.

Furthermore, as mentioned, backboard 2200 does not include a rigid backplate 2202 in some configurations. Instead, patient 2201 lays supine on a surface, such as the ground or a gurney, and inflatable portion 2210 is deployed to travel under the patient's back and lift patient 2201 from the surface on which they are laying. Deploying inflatable portion 2210 may occur in the sequence described above, or in any additional or alternative sequences described herein. Thus, inflatable portion 2210 is configured to provide a supportive surface that can easily be positioned under a patient without needing to maneuver the patient's body.

Although inflatable portion 2210 has thus far been described as being deployed by inflating all low friction chambers 2212 first, still other inflation sequences are utilized in additional or alternative configurations. For example, in some configurations, low friction chambers 2212 are inflated in a sequential order, beginning with the chamber closest to one of support legs 2204 or closest to the centerline. Inflatable portion 2210 may therefore be understood as having individual chambers that can be inflated in sequential orders like those described with regard to FIGS. 19-21. High friction chambers 2214, similarly, need not be inflated all at once when deploying inflatable portion 2210. Rather, in configurations, high friction chambers 2214 are also inflated in a sequential order like those described with regard to FIGS. 19-21, beginning with either the chamber closest to support legs 2204 or closest to the centerline. Moreover, with any of the described inflation sequences, particular chambers need not be fully inflated before beginning to inflate other chambers. In a sequence inflating all low friction chambers 2212 first, for example, low friction chambers 2212 may be only partially inflated when high friction chambers 2214 begin inflating.

FIG. 23 shows a backboard 2300 with an inflatable portion 2310, according to additional configurations of the disclosure. Backboard 2300, as shown, is similar to the example backboard described with regard to FIG. 2200. That is, backboard 2300 has a rigid backplate 2302, and it is implemented with a CPR device having support legs 2304 and a piston 2350 and suction cup 2355 for performing compressions to the chest of a patient 2301. Backboard 2300 also has an inflatable portion 2310 configured to inflate from support legs 2204 to a centerline of the CPR device, and inflatable portion 2310 is formed of low friction chambers 2312 and high friction chambers 2314.

Deployment of inflatable portion 2310, in configurations, follows inflation sequences the same or similar to those just described with regard to the example backboard of FIG. 22. That is, inflatable portion 2310 is configured to inflate from support legs 2304, under patient 2301, and toward the centerline. Inflatable portion 2310 is thus configured to travel underneath patient 2301 and engage the patient's back to lift them from a surface, whether the CPR device implements a rigid backplate 2302 or not.

Different from the example just described with regard to FIG. 22, however, inflatable portion 2310 of backboard 2300 includes high friction chambers 2314 having suction cups 2315 to engage the patient's back. In other words, while low friction chambers 2312 are formed of a substantially flexible material having a low coefficient of friction, high friction chambers 2314 resist slip through the implementation of suction cups 2315. High friction chambers 2314, in configurations, need not be formed of a particular material with suction cups 2315 providing engagement with the patient's back.

In implementation, inflatable portion 2310 is deployed by first inflating all low friction chambers 2312, in some configurations. With only low friction chambers 2312 inflated, low friction chambers 2312 rise above high friction chambers 2314, and the low friction material of low friction chambers 2312 allows inflatable portion 2310 to slide under the patient's back, without suction cups 2315 attaching to the patient. Once low friction chambers 2312 are inflated, and inflatable portion 2310 is positioned under the patient's back, high friction chambers 2314 are inflated to push suction cups 2315 against patient 2301.

In some configurations, inflating high friction chambers 2314 to push suction cups 2315 against patient 2301 provides the pressure necessary to evacuate suction cups 2315, causing suction cups 2315 to attach to patient 2301. In still other configurations, a vessel configured to move a fluid, such as air, to inflate high friction chambers 2314 and low friction chambers 2312 is also used to evacuate suction cups 2315. Put differently, a device for performing both pump and vacuum functions can be implemented to both inflate the chambers of backboard 2300 and remove air from suction cups 2315.

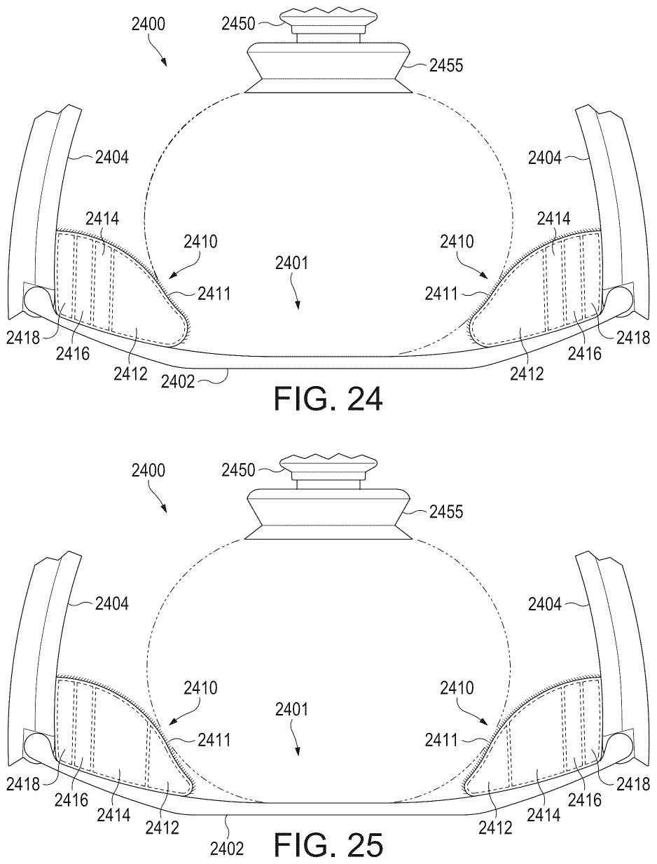

FIG. 24 shows an embodiment of a backboard 2400 with an inflatable portion 2410, according to additional configurations of the disclosure. Backboard 2400, in some configurations, has a rigid backplate 2402, and backboard 2400 is implemented with a CPR device having support legs 2404 and a piston 2450 and suction cup 2455 for delivering compressions. However, as discussed with regard to other example backboards, some configurations of backboard 2400 do not have a rigid backplate 2402 at all. Instead, in additional or alternative configurations, inflatable portion 2410 of backboard 2400 is configured to deploy directly beneath the back of a patient laying supine on a surface.

Inflatable portion 2410 of backboard 2400, in some configurations, is made of two separate portions that inflate from each of support legs 2404 toward the centerline of the CPR device. Nonetheless, in still other configurations, inflatable portion 2410 is a single component configured to inflate from one support leg to the opposite support leg, traveling under patient 2401. When inflatable portion 2410 is not inflated, inflatable portion 2410 fit substantially flat against each of support legs 2404. Additionally, inflatable portion 2410 comprises multiple independent chambers, in configurations. As will be described further below, sequences of inflating the chambers of inflatable portion 2410 allow for inflatable portion 2410 to travel underneath patient 2401.

For example, referring to FIG. 24, a first chamber 2412 of inflatable portion 2410 may be fully inflated first to begin moving inflatable portion 2410 across backplate 2402. As first chamber 2412 is inflated, bristles 2411 disposed on an outer surface of inflatable portion 2410 perform a gripping function to allow inflatable portion 2410 to travel under the patient's back. When first chamber 2412 is inflated, the remaining chambers—second chamber 2414, third chamber 2416, and fourth chamber 2418—remain uninflated. As illustrated in FIG. 24, first chamber 2412 is a chamber of inflatable portion 2410 nearest the centerline of the CPR device. However, as previously mentioned, chambers are designated for clarity and convenience, and orientational and numerical designations should not be interpreted as limiting.

As shown in FIG. 24, inflating first chamber 2412 causes first chamber 2412 to expand and widen, and bristles 2411 of inflatable portion 2410 begin to grip patient 2401. Referring now to FIG. 25, in configurations, an inflation sequence is followed such that first chamber 2412 begins to deflate as second chamber 2414 inflates. Inflating second chamber 2414 causes second chamber 2414 to widen and expand, pushing inflatable portion 2410 closer to the centerline. Deflating first chamber 2412 then allows first chamber 2412 to travel under patient 2401 as it is pushed by second chamber 2414. Additionally, with first chamber 2412 being deflated, bristles 2411 provide less friction and therefore less grip on patient 2401, allowing first chamber 2412 to more easily slide under patient 2401. This sequence is repeated, such that third chamber 2416 is inflated while second chamber 2414 is deflated, and fourth chamber 2418 is inflated while third chamber 2416 is deflated.

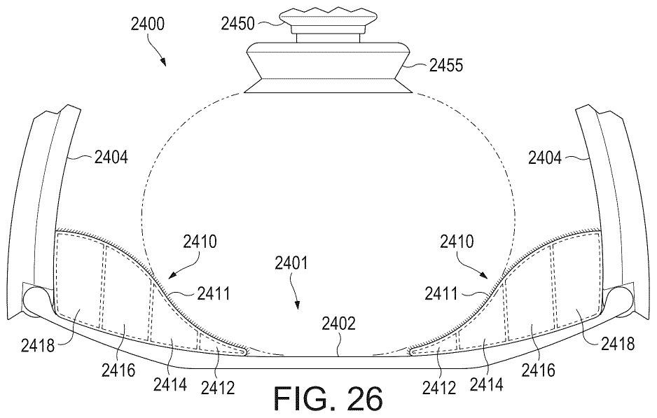

Once fourth chamber 2418 has been inflated, inflatable portion 2410 has been pushed closer to the centerline and is in an appropriate position beneath patient 2401. At this point, and as best shown in FIG. 26, all chambers of inflatable portion 2410 are inflated simultaneously. Inflating all chambers in this way lifts patient 2401 from backplate 2402—or from a surface, in configurations lacking backplate 2402. Bristles 2411, with their gripping qualities, assist in engaging the patient's back when all chambers are inflated.

The inflated chambers of inflatable portion 2410, being filled with a fluid like air, tend to provide pressure against patient 2401 when patient 2401 moves toward either of support legs 2404. Specifically, the regions of inflatable portion 2410 interfacing with the sides of patient 2401 counter movement of patient 2401 when patient 2401 shifts and presses against inflatable portion 2410.

As mentioned, in some configurations, backboard 2400 does not include a rigid backplate 2402 at all. Instead, patient 2401 is positioned laying supine on a surface, such as the ground or a gurney, and a CPR device utilizing backboard 2400 is positioned over patient 2401. Deploying inflatable portion 2410 in the sequence described with regard to FIGS. 24-26 causes inflatable portion 2410 to travel under the patient's back and ultimately lift patient 2401 from the surface on which they are laying. Accordingly, inflatable portion 2410 provides a supportive surface for the patient's back that can be easily positioned without needing to maneuver the body of patient 2401.

Furthermore, although FIGS. 24-26 shows an example backboard 2400 having four chambers forming inflatable portion 2410, still other configurations of backboard 2400 have a greater or fewer number of independent chambers. It should be understood that the example backboard 2400 and the described inflation sequence corresponding to four chambers are not exhaustive, and additional or alternative inflation sequences may be utilized depending on the number of independent chambers forming inflatable portion 2410.

### EXAMPLES

Illustrative examples of the disclosed technologies are provided below. A particular configuration of the technologies may include one or more, and any combination of, the examples described below.

Example 1 includes a backboard for a mechanical CPR device, the backboard comprising: a backplate having a footprint; a first inflatable chamber coupled to the backplate, the first inflatable chamber, when inflated, configured to extend away from the backplate snugly against a shoulder of a patient and a top side of an extended arm of the patient; and a second inflatable chamber coupled to the backplate, the second inflatable chamber, when inflated, configured to extend away from the backplate snugly against a side of the patient and an underside of the extended arm of the patient.

Example 2 includes the backboard of Example 1, further comprising: a third inflatable chamber coupled to the backplate, the third inflatable chamber, when inflated, configured to extend away from the backplate snugly against a second shoulder of the patient and a top side of a second extended arm of the patient; and a fourth inflatable chamber coupled to the backplate, the fourth inflatable chamber, when inflated, configured to extend away from the backplate snugly against a second side of the patient and an underside of the second extended arm of the patient.

Example 3 includes the backboard of Example 2, further comprising: a fifth inflatable chamber coupled to the backplate, the fifth inflatable chamber, when inflated, configured to fit within the footprint of the backplate snugly against a first side of an upper abdomen of the patient; and a sixth inflatable chamber coupled to the backplate, the sixth inflatable chamber, when inflated, configured to extend away from the backplate snugly against a first side of a lower abdomen of the patient.

Example 4 includes the backboard of Example 3, further comprising: a seventh inflatable chamber coupled to the backplate, the seventh inflatable chamber, when inflated, configured to fit within the footprint of the backplate snugly against a second side of the upper abdomen of the patient; and an eighth inflatable chamber coupled to the backplate, the eighth inflatable chamber, when inflated, configured to extend away from the backplate snugly against a second side of the lower abdomen of the patient.

Example 5 includes the backboard of any of Examples 1-4, in which the first inflatable chamber and the second inflatable chamber, when deflated, are configured to fold substantially flat onto the backplate and have a folded footprint not larger than the footprint of the backplate.

Example 6 includes the backboard of any of Examples 4-5, in which the first inflatable chamber, the second inflatable chamber, the third inflatable chamber, the fourth inflatable chamber, the fifth inflatable chamber, the sixth inflatable chamber, the seventh inflatable chamber, and the eighth inflatable chamber are configured to fold substantially flat onto the backplate and have a folded footprint not larger than the footprint of the backplate.

Example 7 includes the backboard of any of Examples 1-6, in which the backboard is configured to be implemented with the CPR device to apply cardiopulmonary resuscitation (CPR) chest compressions to the chest of the patient.

Example 8 includes the backboard of Example 7, in which a pressure of each of the first inflatable chamber and the second inflatable chamber is controlled by a controller of the CPR device during application of CPR chest compressions.

Example 9 includes the backboard of Example 8, in which a pressure of the third inflatable chamber is controlled by the controller of the CPR device during application of CPR chest compressions.

Example 10 includes the backboard of Example 8, in which the controller of the mechanical CPR device is configured to adjust the pressure of each of the first inflatable chamber and the second inflatable chamber to prevent migration of the CPR device from a preset optimal compression location on the chest of the patient.

Example 11 includes the backboard of Example 9, in which the controller of the mechanical CPR device is configured to adjust the pressure of each of the first inflatable chamber and the third inflatable chamber to prevent migration of the CPR device from a preset optimal compression location on the chest of the patient.

Example 12 includes the backboard of any of Examples 7-11, the CPR device further comprising a first restraint configured to secure the patient to the mechanical CPR device.

Example 13 includes a mechanical cardiopulmonary resuscitation (CPR) device for applying CPR chest compressions to a chest of a patient, the mechanical CPR device comprising: a backboard, including: a backplate having a footprint; a first inflatable chamber coupled to the backplate, the first inflatable chamber, when inflated, configured to extend away from the backplate snugly against a shoulder of a patient and a top side of an extended arm of the patient; a second inflatable chamber coupled to the backplate, the second inflatable chamber, when inflated, configured to extend away from the backplate snugly against a side of the patient and an underside of the extended arm of the patient; and a restraint configured to secure the patient to the mechanical CPR device, the restraint configured to interface with a nape the patient's neck.

Example 14 includes the mechanical CPR device of Example 13, the backboard further including: a third inflatable chamber coupled to the backplate, the third inflatable chamber, when inflated, configured to extend away from the backplate snugly against a second shoulder of the patient and a top side of a second extended arm of the patient; and a fourth inflatable chamber coupled to the backplate, the fourth inflatable chamber, when inflated, configured to extend away from the backplate snugly against a second side of the patient and an underside of the second extended arm of the patient.

Example 15 includes the mechanical CPR device of Example 14, the backboard further including: a fifth inflatable chamber coupled to the backplate, the fifth inflatable chamber, when inflated, configured to fit within the footprint of the backplate snugly against a first side of an upper abdomen of the patient; and a sixth inflatable chamber coupled to the backplate, the sixth inflatable chamber, when inflated, configured to extend away from the backplate snugly against a first side of a lower abdomen of the patient.

Example 16 includes the mechanical CPR device of Example 15, the backboard further including: a seventh inflatable chamber coupled to the backplate, the seventh inflatable chamber, when inflated, configured to fit within the footprint of the backplate snugly against a second side of the upper abdomen of the patient; and an eighth inflatable chamber coupled to the backplate, the eighth inflatable chamber, when inflated, configured to extend away from the backplate snugly against a second side of the lower abdomen of the patient.

Example 17 includes the mechanical CPR device of any of Examples 13-16, in which the first inflatable chamber and the second inflatable chamber, when deflated, are configured to fold substantially flat onto the backplate and have a folded footprint not larger than the footprint of the backplate.

Example 18 includes the mechanical CPR device of any of Examples 16-17, in which the first inflatable chamber, the second inflatable chamber, the third inflatable chamber, the fourth inflatable chamber, the fifth inflatable chamber, the sixth inflatable chamber, the seventh inflatable chamber, and the eighth inflatable chamber are configured to fold substantially flat onto the backplate and have a folded footprint not larger than the footprint of the backplate.

Example 19 includes the mechanical CPR device of any of Examples 13-18, in which a pressure of each of the first inflatable chamber and the second inflatable chamber is controlled by a controller of the CPR device during application of CPR chest compressions.

Example 20 includes the mechanical CPR device of Example 19, in which a pressure of the third inflatable chamber is controlled by the controller of the CPR device during application of CPR chest compressions.

Example 21 includes the mechanical CPR device of Example 19, in which the controller of the mechanical CPR device is configured to adjust the pressure of each of the first inflatable chamber and the second inflatable chamber to prevent migration of the CPR device from a preset optimal compression location on the chest of the patient.

Example 22 includes the mechanical CPR device of Example 20, in which the controller of the mechanical CPR device is configured to adjust the pressure of each of the first inflatable chamber and the third inflatable chamber to prevent migration of the CPR device from a preset optimal compression location on the chest of the patient.

Example 23 includes a mechanical cardiopulmonary resuscitation (CPR) device, comprising: a backboard configured to receive and support a back of a patient laying supine; a compression mechanism configured to apply successive CPR compressions to a chest of the patient; a support structure configured to position the compression mechanism at a distance from the chest of the patient and over a first location on the chest of the patient when the patient is in a first position on the backboard; and a first lateral adjustment component removably coupled with the backboard at a first side of the backboard, the lateral adjustment component structured to move the patient from the first position to a second position, wherein the compression mechanism is over a second location on the chest of the patient when the patient is in the second position.

Example 24 includes the mechanical CPR device of Example 23, in which the first lateral adjustment component is a wedge between the backboard and the back of the patient, the wedge having a flat orientation corresponding to the first position of the patient and an inclined orientation corresponding to the second position of the patient.

Example 25 includes the mechanical CPR device of Example 24, in which an inflatable chamber between the wedge and the backboard transitions the wedge between the inclined orientation and the flat orientation, the inflatable chamber placing the wedge in the inclined orientation when the inflatable chamber is inflated, and the inflatable chamber placing the wedge in the flat orientation when the inflatable chamber is deflated.

Example 26 includes the mechanical CPR device of Example 24, in which a rack and latch mechanism transitions the wedge between the inclined orientation and the flat orientation.

Example 27 includes the mechanical CPR device of Example 23, in which the first lateral adjustment component is a bag attached to the backboard, the bag being filled with a vacuum sealed foam configured to expand when a valve on the bag is opened.

Example 8 includes the mechanical CPR device of any of Examples 23-27, in which the first lateral adjustment component is further configured to move the patient to a third position, wherein the compression mechanism is over a third location on the chest of the patient when the patient is in the third position.

Example 29 includes the mechanical CPR device of any of Examples 23-28, further comprising: a sensor configured to measure a compression parameter during application of CPR compressions and output a signal indicating the measured compression parameter; and a controller configured to receive the measured compression parameter from the sensor and to control the lateral adjustment component to move the patient from the first position to the second position, based at least in part on the measured compression parameter.

Example 30 includes the mechanical CPR device of any of Examples 23-29, further comprising a second lateral adjustment component removably coupled with the backboard at a second side of the backboard.

Example 31 includes a method of laterally adjusting a compression location on a chest of a patient during performance of cardiopulmonary resuscitation (CPR) compressions with a mechanical CPR device, the method comprising the steps of: positioning the patient in a first position on a backboard of the mechanical CPR device, the backboard having a lateral adjustment component initially in a flat orientation; performing CPR compressions at a first location on the chest of the patient; adjusting the lateral adjustment component to a first inclined orientation, wherein adjusting the lateral adjustment component to the first inclined orientation positions the patient in a second position; and performing CPR compressions at a second location on the chest of the patient.

Example 32 includes the method of Example 31, in which adjusting the lateral adjustment component comprises inflating an inflatable chamber between the backboard and the lateral adjustment component.

Example 33 includes the method of Example 31, in which adjusting the lateral adjustment component comprises using a rack and latch mechanism.

Example 34 includes the method of Example 31, in which adjusting the lateral adjustment component comprises opening a valve on a bag having a vacuum sealed foam configured to expand when the valve is opened.

Example 35 includes the method of any of Examples 31-34, further comprising the steps of: adjusting the lateral adjustment component to a second inclined orientation, wherein adjusting the lateral adjustment component to the second inclined orientation positions the patient in a third position; and performing CPR compressions at a third location on the chest of the patient.

Example 36 includes a mechanical cardiopulmonary resuscitation (CPR) device, comprising: a compression mechanism configured to deliver compressions to a chest of a patient; a support leg structured to position the compression mechanism over the chest of the patient laying supine on a surface; an inflatable backboard configured to support a back of the patient, the inflatable backboard further configured to inflate from a first position substantially flat against the support leg to a second position between the back of the patient and the surface.

Example 37 includes the mechanical CPR device of Example 36, in which the inflatable backboard is configured to lift the patient from the surface as it is inflated.

Example 38 includes the mechanical CPR device of any of Examples 36-37, further comprising bristles disposed on the inflatable backboard.

Example 39 includes the mechanical CPR device of any of Examples 36-38, in which the inflatable backboard comprises a high friction portion and a low friction portion.

Example 40 includes the mechanical CPR device of Example 39, in which the high friction portion of the inflatable backboard comprises a plurality of suction cups disposed on the inflatable backboard.

Example 41 includes the mechanical CPR device of any of Examples 39-40, in which the high friction portion comprises a plurality of chambers formed from a high friction material, the low friction portion comprises a plurality of chambers formed from a low friction material, and in which the inflatable backboard is inflated in sequence in which the low friction portion is fully inflated before the high friction portion is inflated.

Example 42 includes the mechanical CPR device of any of Examples 36-41, in which the inflatable backboard comprises a plurality of independent chambers configured to be inflated in a sequence.

Example 43 includes the mechanical CPR device of Example 42, in which the plurality of independent chambers comprises a first chamber nearest the support leg and a second chamber nearest a centerline of the mechanical CPR device, and in which the sequence for inflating the plurality of independent chambers comprises inflating the first chamber before inflating the second chamber.

Example 44 includes the mechanical CPR device of Example 42, in which the plurality of independent chambers comprises a first chamber nearest the support leg and a second chamber nearest a centerline of the mechanical CPR device, and in which the sequence for inflating the plurality of independent chambers comprises inflating the second chamber before inflating the first chamber.

Example 45 includes the mechanical CPR device of Example 42, in which the plurality of independent chambers comprises a first chamber nearest the support leg and a second chamber nearest a centerline of the mechanical CPR device, and in which the sequence for inflating the plurality of independent chambers comprises inflating the first chamber, then deflating the first chamber while inflating the second chamber, then inflating both the first chamber and the second chamber.

Example 46 includes a mechanical cardiopulmonary resuscitation (CPR) device, comprising: a compression mechanism configured to deliver compressions to a chest of a patient; a support leg structured to position the compression mechanism over the chest of the patient laying supine on a surface; an inflatable backboard configured to support a back of the patient, the inflatable backboard having a plurality of independent chambers configured to inflate in a sequence to transition the inflatable backboard from a first position substantially flat against the support leg to a second position between the back of the patient and the surface.

Example 47 includes the mechanical CPR device of Example 46, in which the plurality of independent chambers comprises a first chamber nearest the support leg and a second chamber nearest a centerline of the mechanical CPR device, and in which the sequence for inflating the plurality of independent chambers comprises inflating the first chamber before inflating the second chamber.

Example 48 includes the mechanical CPR device of Example 46, in which the plurality of independent chambers comprises a first chamber nearest the support leg and a second chamber nearest a centerline of the mechanical CPR device, and in which the sequence for inflating the plurality of independent chambers comprises inflating the second chamber before inflating the first chamber.

Example 49 includes the mechanical CPR device of Example 46, in which the plurality of independent chambers comprises a first chamber nearest the support leg and a second chamber nearest a centerline of the mechanical CPR device, and in which the sequence for inflating the plurality of independent chambers comprises inflating the first chamber, then deflating the first chamber while inflating the second chamber, then inflating both the first chamber and the second chamber.

Example 50 includes the mechanical CPR device of any of Examples 46-49, in which the inflatable backboard is configured to lift the patient from the surface as it is inflated.

Example 51 includes the mechanical CPR device of any of Examples 46-50, further comprising bristles disposed on the inflatable backboard.

Example 52 includes the mechanical CPR device of any of Examples 46-50, in which a first portion of the plurality of independent chambers are high friction chambers and second portion of the plurality of independent chambers are low friction chambers.

Example 53 includes the mechanical CPR device of Example 52, in which the high friction chambers comprise a plurality of suction cups disposed on the inflatable backboard.

Example 54 includes the mechanical CPR device of any of Examples 52-53, in which the sequence for inflating the inflatable backboard comprises inflating the low friction chambers before inflating the high friction chambers.

Example 55 includes a mechanical cardiopulmonary resuscitation (CPR) device, comprising: a compression mechanism configured to deliver compressions to a chest of a patient; a support leg structured to position the compression mechanism over the chest of the patient laying supine on a surface; an inflatable backboard configured to support a back of the patient, the inflatable backboard having a plurality of independent chambers configured to inflate in a sequence to transition the inflatable backboard from a first position substantially flat against the support leg to a second position between the back of the patient and the surface, the inflatable backboard further having a high friction surface to engage the back of the patient and lift the patient from the surface.

Example 56 includes the mechanical CPR device of Example 55, in which the plurality of independent chambers comprises a first chamber nearest the support leg and a second chamber nearest a centerline of the mechanical CPR device, and in which the sequence for inflating the plurality of independent chambers comprises inflating the first chamber before inflating the second chamber.

Example 57 includes the mechanical CPR device of Example 55, in which the plurality of independent chambers comprises a first chamber nearest the support leg and a second chamber nearest a centerline of the mechanical CPR device, and in which the sequence for inflating the plurality of independent chambers comprises inflating the second chamber before inflating the first chamber.

Example 58 includes the mechanical CPR device of Example 55, in which the plurality of independent chambers comprises a first chamber nearest the support leg and a second chamber nearest a centerline of the mechanical CPR device, and in which the sequence for inflating the plurality of independent chambers comprises inflating the first chamber, then deflating the first chamber while inflating the second chamber, then inflating both the first chamber and the second chamber.

Example 59 includes the mechanical CPR device of any of Examples 55-58, further comprising bristles disposed on the inflatable backboard.

Example 60 includes the mechanical CPR device of any of Examples 55-59, in which a first portion of the plurality of independent chambers are high friction chambers and second portion of the plurality of independent chambers are low friction chambers.

Example 61 includes the mechanical CPR device of Example 60, in which the high friction chambers comprise a plurality of suction cups disposed on the inflatable backboard.

Example 62 includes the mechanical CPR device of any of Examples 60-61, in which the sequence for inflating the inflatable backboard comprises inflating the low friction chambers before inflating the high friction chambers.

Aspects may operate on a particularly created hardware, on firmware, digital signal processors, or on a specially programmed general purpose computer including a processor operating according to programmed instructions. The terms “controller” or “processor” as used herein are intended to include microprocessors, microcomputers, ASICs, and dedicated hardware controllers. One or more aspects may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, RAM, etc. As will be appreciated by one of skill in the art, the functionality of the program modules may be combined or distributed as desired in various configurations. In addition, the functionality may be embodied in whole or in part in firmware or hardware equivalents such as integrated circuits, field programmable gate arrays (FPGA), and the like. Particular data structures may be used to more effectively implement one or more aspects of the disclosed systems and methods, and such data structures are contemplated within the scope of computer executable instructions and computer-usable data described herein.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular example configuration, that feature can also be used, to the extent possible, in the context of other example configurations.

Also, when reference is made in this application to a method having two or more defined steps or operations, the defined steps or operations can be carried out in any order or simultaneously, unless the context excludes those possibilities.

Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components.

Also, directions such as “vertical,” “horizontal,” “right,” and “left” are used for convenience and in reference to the views provided in figures. But the described CPR device and backboard configurations may have a number of orientations in actual use. Thus, a feature that is vertical, horizontal, to the right, or to the left in the figures may not have that same orientation or direction in actual use.

Although specific example configurations have been described for purposes of illustration, it will be understood that various modifications may be made without departing from the spirit and scope of the disclosure.

We claim:

1. A backboard for a mechanical CPR device, the backboard comprising:
a backplate having a footprint;
a first inflatable chamber coupled to the backplate, the first inflatable chamber, when inflated, configured to extend away from the backplate snugly against a shoulder of a patient and a top side of an extended arm of the patient; and
a second inflatable chamber coupled to the backplate, the second inflatable chamber, when inflated, configured to extend away from the backplate snugly against a side of the patient and an underside of the extended arm of the patient.

2. The backboard of claim 1, further comprising:
a third inflatable chamber coupled to the backplate, the third inflatable chamber, when inflated, configured to extend away from the backplate snugly against a second shoulder of the patient and a top side of a second extended arm of the patient; and
a fourth inflatable chamber coupled to the backplate, the fourth inflatable chamber, when inflated, configured to extend away from the backplate snugly against a second side of the patient and an underside of the second extended arm of the patient.

3. The backboard of claim 2, further comprising:
a fifth inflatable chamber coupled to the backplate, the fifth inflatable chamber, when inflated, configured to fit within the footprint of the backplate snugly against a first side of an upper abdomen of the patient; and
a sixth inflatable chamber coupled to the backplate, the sixth inflatable chamber, when inflated, configured to extend away from the backplate snugly against a first side of a lower abdomen of the patient.

4. The backboard of claim 3, further comprising:
a seventh inflatable chamber coupled to the backplate, the seventh inflatable chamber, when inflated, configured to fit within the footprint of the backplate snugly against a second side of the upper abdomen of the patient; and
an eighth inflatable chamber coupled to the backplate, the eighth inflatable chamber, when inflated, configured to extend away from the backplate snugly against a second side of the lower abdomen of the patient.

5. The backboard of claim 1, in which the first inflatable chamber and the second inflatable chamber, when deflated, are configured to fold substantially flat onto the backplate and have a folded footprint not larger than the footprint of the backplate.

6. The backboard of claim 4, in which the first inflatable chamber, the second inflatable chamber, the third inflatable chamber, the fourth inflatable chamber, the fifth inflatable chamber, the sixth inflatable chamber, the seventh inflatable chamber, and the eighth inflatable chamber are configured to fold substantially flat onto the backplate and have a folded footprint not larger than the footprint of the backplate.

7. The backboard of claim 1, in which the backboard is configured to be implemented with the CPR device to apply cardiopulmonary resuscitation (CPR) chest compressions to the chest of the patient.

8. The backboard of claim 7, in which a pressure of each of the first inflatable chamber and the second inflatable chamber is controlled by a controller of the CPR device during application of CPR chest compressions.

9. The backboard of claim 8, in which a pressure of the third inflatable chamber is controlled by the controller of the CPR device during application of CPR chest compressions.

10. The backboard of claim 8, in which the controller of the mechanical CPR device is configured to adjust the pressure of each of the first inflatable chamber and the second inflatable chamber to prevent migration of the CPR device from a preset optimal compression location on the chest of the patient.

11. The backboard of claim 9, in which the controller of the mechanical CPR device is configured to adjust the pressure of each of the first inflatable chamber and the third inflatable chamber to prevent migration of the CPR device from a preset optimal compression location on the chest of the patient.

12. The backboard of claim 7, the CPR device further comprising a first restraint configured to secure the patient to the mechanical CPR device.

13. A mechanical cardiopulmonary resuscitation (CPR) device for applying CPR chest compressions to a chest of a patient, the mechanical CPR device comprising:
a backboard, including:
a backplate having a footprint;
a first inflatable chamber coupled to the backplate, the first inflatable chamber, when inflated, configured to extend away from the backplate snugly against a shoulder of a patient and a top side of an extended arm of the patient;
a second inflatable chamber coupled to the backplate, the second inflatable chamber, when inflated, configured to extend away from the backplate snugly against a side of the patient and an underside of the extended arm of the patient; and
a restraint configured to secure the patient to the mechanical CPR device, the restraint configured to interface with a nape the patient's neck.

14. The mechanical CPR device of claim 13, the backboard further including:
a third inflatable chamber coupled to the backplate, the third inflatable chamber, when inflated, configured to extend away from the backplate snugly against a second shoulder of the patient and a top side of a second extended arm of the patient; and
a fourth inflatable chamber coupled to the backplate, the fourth inflatable chamber, when inflated, configured to extend away from the backplate snugly against a second side of the patient and an underside of the second extended arm of the patient.

15. The mechanical CPR device of claim 14, the backboard further including:
a fifth inflatable chamber coupled to the backplate, the fifth inflatable chamber, when inflated, configured to fit within the footprint of the backplate snugly against a first side of an upper abdomen of the patient; and
a sixth inflatable chamber coupled to the backplate, the sixth inflatable chamber, when inflated, configured to extend away from the backplate snugly against a first side of a lower abdomen of the patient.

16. The mechanical CPR device of claim 15, the backboard further including:
a seventh inflatable chamber coupled to the backplate, the seventh inflatable chamber, when inflated, configured to fit within the footprint of the backplate snugly against a second side of the upper abdomen of the patient; and
an eighth inflatable chamber coupled to the backplate, the eighth inflatable chamber, when inflated, configured to extend away from the backplate snugly against a second side of the lower abdomen of the patient.

17. The mechanical CPR device of claim 13, in which the first inflatable chamber and the second inflatable chamber, when deflated, are configured to fold substantially flat onto the backplate and have a folded footprint not larger than the footprint of the backplate.

18. The mechanical CPR device of claim 16, in which the first inflatable chamber, the second inflatable chamber, the third inflatable chamber, the fourth inflatable chamber, the fifth inflatable chamber, the sixth inflatable chamber, the seventh inflatable chamber, and the eighth inflatable chamber are configured to fold substantially flat onto the backplate and have a folded footprint not larger than the footprint of the backplate.

19. The mechanical CPR device of claim 13, in which a pressure of each of the first inflatable chamber and the second inflatable chamber is controlled by a controller of the CPR device during application of CPR chest compressions.

20. The mechanical CPR device of claim 19, in which a pressure of the third inflatable chamber is controlled by the controller of the CPR device during application of CPR chest compressions.

21. The mechanical CPR device of claim 19, in which the controller of the mechanical CPR device is configured to adjust the pressure of each of the first inflatable chamber and the second inflatable chamber to prevent migration of the CPR device from a preset optimal compression location on the chest of the patient.

22. The mechanical CPR device of claim 20, in which the controller of the mechanical CPR device is configured to adjust the pressure of each of the first inflatable chamber and the third inflatable chamber to prevent migration of the CPR device from a preset optimal compression location on the chest of the patient.
